(19) United States
(12) Patent Application Publication
(10) Pub. No.: US 2015/0227953 A1
(43) Pub. Date: Aug. 13, 2015

(54) HOLDING ACCESS PRICE CONSTANT FOR SELECTED TIME WHEN ACCESS PRICES CHANGE DYNAMICALLY IN AN AUTOMATES SYSTEM FOR DELIVERING REASONABLY PRICED ACCESS TO CONTENT

(71) Applicant: QBEATS INC., New York, NY (US)

(72) Inventor: Illan Poreh, Miami Beach, FL (US)

(21) Appl. No.: 14/420,333

(22) PCT Filed: Aug. 8, 2013
(86) PCT No.: PCT/US2013/054231

§ 371 Date: Feb. 6, 2015

Related U.S. Application Data
(60) Provisional application No. 61/681,073, filed on Aug. 8, 2012.

(51) Int. Cl. G06Q 30/02

(52) U.S. Cl. CPC G06Q 30/0206; G06Q 30/0269

(57) ABSTRACT

A computer-implemented system and method that provide dynamic, essentially real time pricing of users' access to content represented by articles, which pricing varies over time with user behavior to reflect actual values that users place on access to the articles. The system includes an improvement that freezes the access price of an article for some period of time after a user selects the article to enable the user to make a purchasing decision based on the access price at a time related to the time the user selected the article, while the access price for the same article may change for other users.

### REFERENCE TO RELATED APPLICATIONS

This patent application is related to and claims priority of U.S. Provisional patent application No. 61/681,073 filed Aug. 8, 2012. This patent application also is related to PCT application PCT/US12/39129 filed May 23, 2012 (which claims the benefit of U.S. provisional patent application 61/488,850 filed on May 23, 2011), and to U.S. non-provisional patent application Ser. No. 13/404,957 filed Feb. 24, 2012.

### FIELD

This patent specification pertains to holding constant for some time certain prices for access articles before users complete the purchase of access, in the environment of a basic computerized system that gives remote users paid or unpaid access via electronic links to content from numerous publishers, and dynamically prices access in accordance with user behavior.

### BACKGROUND AND SUMMARY OF THE DISCLOSURE

The improvement regarding to holding prices constant for some time to allow a user to consider the purchase of access is implemented in a basic automated, computerized system that enables remote publishers (who may be users as well) to upload content and provides users with remote access to content from numerous publishers and with convenient search facilities. Users in different categories may gain free access to some of the content, or paid access. The price for access to an article can vary from one content item to another and over time for each item, based on factors and processes that can be adapted for particular goals, such as to increase revenue to publishers and the system and at the same time reduce the cost of access to users. The dynamic pricing makes it possible for users to gain access to content at relatively low prices, or for free, and at the same time tends to increase the revenue to a publisher for a given content item because of increased numbers of users who purchase access.

A user's screen can show a listing of articles and respective access prices posted for each of at least some of the articles. A user can click on an article or a symbol associated with the article to purchase access, in response to which the article appears on the user's screen or the user can download it for storage. The price of access to an article can vary depending on events that are essentially real time. This patent specification addresses the issue of possible changes in the access price of an article that the user such as a PPV (pay-per-view) user has selected but has not yet purchased.

The improvement that this patent specification describes a facility that provides better service by enabling a user to purchase access to an article at the access price that existed at the time the user selected the article even in cases where the access price of article has increased by the time the user has performed the steps to complete the purchase of the article to the article. For example, when a user first takes an action related to selecting an article, the system can freeze price changes for that particular user and that particular article for some period of time during which the user can complete the purchase access to that article at the frozen price, although the price for access to the article can continue changing dynamically for other potential users. The action that a user can take to freeze the access price to an article can be selected by the system implementer. One example is when a user highlights the entry for an article on the user's screen. Another example is to freeze the price for access to an article when the user points to the article title or a symbol on the screen associated with the article and presses and continues to hold down the right button on a mouse or a keyboard key or some other computer key, or maintains finger contact with a touch screen area. There can be other examples, such as touching a specified key or screen area without continuing to hold down the key or to maintain contact with the screen area, or some other distinct action. The price freeze period for a particular article can be defined as a time interval, and can differ between articles or classes of users. Alternatively, the price freeze period can be defined in some other way, for example as a time period related to how the access price for an article changes. For example, the time period can be longer for an article whose access price changes slowly or in smaller increments that for a typical article or relative to a preset threshold. The freeze time can be tied to events instead of or in addition to time; for example, the freeze can end when the updated price for an article starts going down or has gone down by a set amount or percentage.

### BRIEF DESCRIPTION OF THE DRAWINGS

FIG. 1 illustrates an example of an overall arrangement of a system for receiving, pricing and distributing content.

FIG. 1A is a flowchart illustrating steps involved in holding the access price for an article constant for a time period before a user completes the purchase of access to the article.

FIG. 2 illustrates an example of a webpage that the system downloads to a screen of a pay-per-view (PPV) user.

FIG. 3 illustrates an example of a screen with various channel groups that the system makes available to a pay-per-view (PPV) user.

FIG. 4 illustrates an example of a screen that the system downloads to a real time user.

FIG. 5 illustrates an example of a synopsis view for an article that opens in response to a user's interaction with the system.

FIG. 6 illustrates a cascade of articles that a user has opened (accessed).

FIG. 7 shows in magnification article tabs that appear in the display of the open article seen in FIG. 6.

FIG. 8 illustrates an example of another magnified portion of the FIG. 6 display.

FIG. 9 illustrates an example where an article includes not only text but also images.

FIGS. 10a and 10b illustrate examples of a publisher's interaction with the system.

FIGS. 11a through 11f further illustrate examples of a publisher's interaction with the system.

FIG. 12 illustrates a portion of the system of FIG. 1.

FIG. 13 illustrates the same portion of the system as FIG. 10 but in a different stage of processing the pricing of the article.

FIGS. 14-21 are self-explanatory examples of different stages of the process of pricing an article in the overall system of FIG. 1.

FIG. 22 is a flowchart illustrating an example of a publisher's interaction with the system.

FIG. 23 is a flowchart illustrating an example of steps in the operation of a pricing engine.

FIG. 24 is a functional block diagram illustrating a currently preferred implementation of an interactive pricing engine application cluster.

FIG. 25 lists and explains symbols used in FIGS. 24-32.

FIG. 26 is a flow diagram illustrating steps in a process of pricing access to an article that takes into account user behavior and other factors.

FIG. 27 lists and explains steps illustrated in FIG. 25.

FIG. 28 illustrates a display screen used in script management.

FIG. 29 illustrates a script management window.

FIG. 30 illustrates pricing script function specification examples.

FIG. 31 illustrates a pricing script code example.

FIG. 32 illustrates an example of statistical information that can be used in pricing access to articles.

### DETAILED DESCRIPTION OF PREFERRED EMBODIMENTS

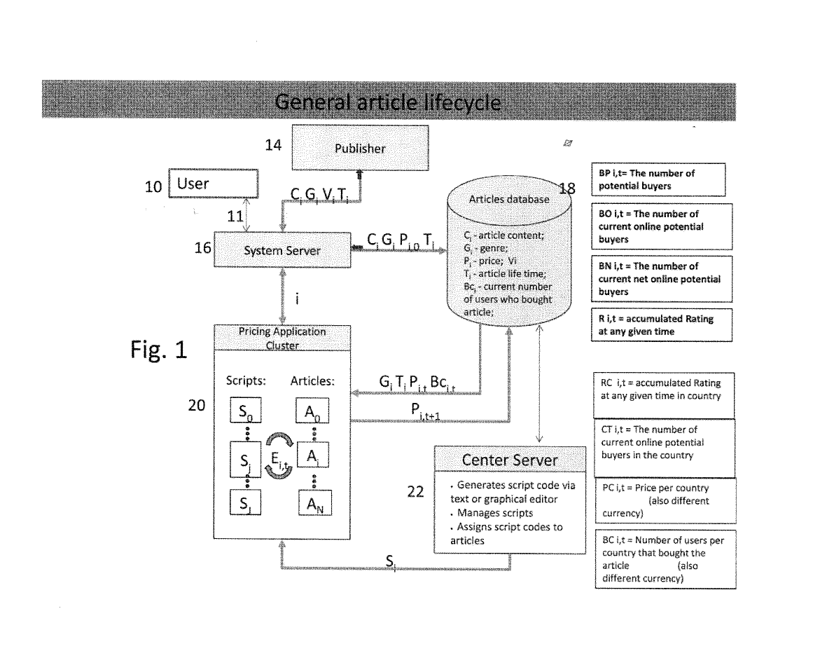

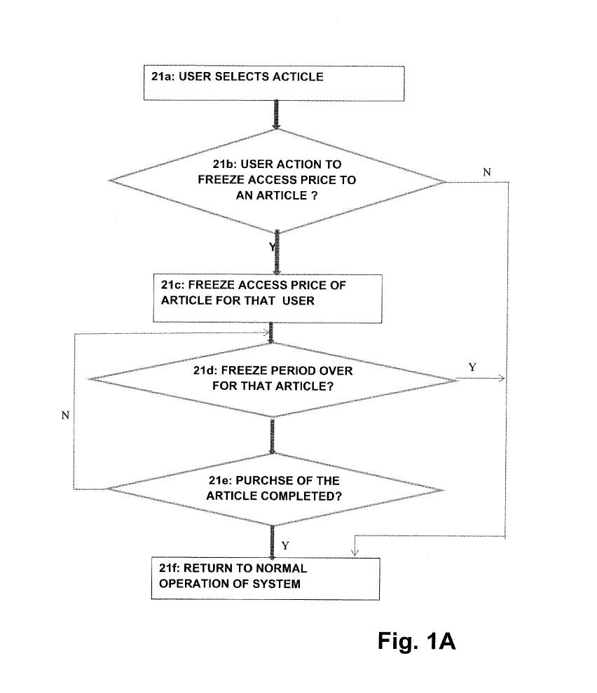

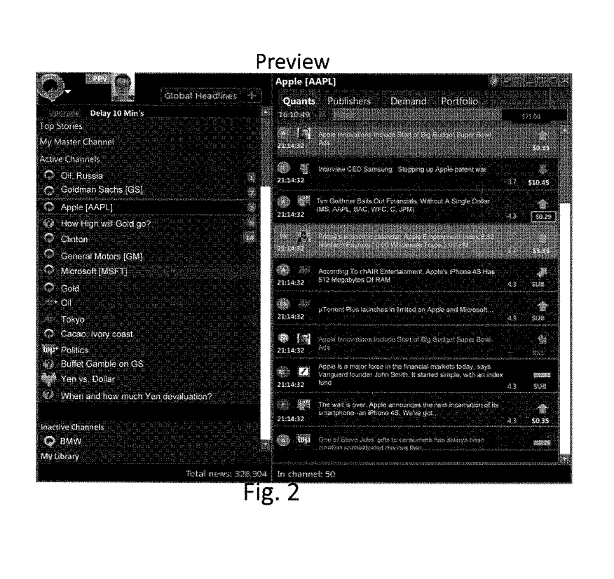

The description below first briefly explains in connection with FIG. 1 the basic system in which the improvement relating to a temporary freeze in the access price for an article is implemented. The improvement itself is described mainly in connection with FIG. 1A. Then, the basic system is further explained in detail connection with FIGS. 2-32.

It may help to explain at the outset several terms used in this patent specification.
“Content” as used herein refers to anything that comprises or represent informational content and includes, as non-limiting examples, written material such as news reports, analysis, interviews, questions and answers to questions, etc., and audio visual information such as speech, music, video, audio, photographs, and still images, etc.
“Article” is shorthand notation for any content, including without limitation a story, a news article or a scientific article, a recorded video, a live video, a prerecorded audio, a live audio, a recorded musical performance, a live musical performance, a photograph, an interview, a question-and-answer exchange, or any other representation, in whatever form or format, that has informational content.
“Answer” refers to information that is provided in response to a question posted in the system and encompasses any content, including articles.
“Publisher” is shorthand notation for any source of content, whether a journalist working as an employee of a publication, the publication itself, a freelance journalist, an author of a scientific paper or article, a music performer, a video provider, a photographer, or any other source or provider of informational content, including answers.
“Lifetime” of an article or answer is used in this patent specification as shorthand notation for a publisher's, a journalist's or the system's expectation or estimate, at any given point in time, of the remaining time period during which users of the system would be willing to pay to read, view or download a specific article or answer.
“Script” is shorthand notation for computer-implemented rules or sets of rules that are applied to information to determine or estimate the price of access to an article or an answer at a given point in time. A script can be implemented in a specific example of the system as a computer instruction, as a program module or sub-module, or in any other manner that serves the intended purpose.
“Server” is used as shorthand notation for a computer facility comprising hardware and/or software and/or firmware that is intended to host applications and carries out the service functions described in this patent specification. When in the singular, the term as used herein encompasses the use of a single server or two or more servers, in each case in the same location or in different locations. Conversely, when this patent specification refers to different servers, their functions may be carried out in a single physical server or in physically separate servers.
“Channel” is a live, customized search avenue that matches users with publishers, and can be based on keywords, topics, specific publications, specific topics, etc. A channel can be preset by the system or set or defined by a user or publisher.
“Granulated” designates access that applies different rules to different classes of publishers, users, or others seeking access to the system—for example granulated access by publishers can mean that some publishers may have free access to all or some answers while others do not, and that some users may have paid access to all content in the system on a subscription basis, some may have paid access to only some of the content, some may separately pay for each item of content, some content may be free to some or all users, and paid access to any article or answer can an typically will change in price over time or upon the occurrence of certain events.

FIG. 1 illustrates in functional form the basic system in which the improvement related to one-click access to and instantaneous delivery of content to users, including delivery of priced content, is incorporated. Consider the example of a publisher 14, for example a freelance journalist. The publisher is at a location remote from the system and uses a connection mechanism such as a personal computer, a tablet or some other device to establish a two-way electronic communication with a computer-implemented or computer-controlled system server 16, for example using a browser and the Internet. The term “electronic” is used in this patent specification in a broad sense to include various computer-controlled ways of communicating such as by optical communications. In response, system server 16 downloads to the publisher's device, over an electronic communication link, a screen display through which the publisher navigates and selects actions such as signing on the system, creating an account and/or a profile, changing settings, selecting or creating an active channel or accessing an inactive channel, submitting an article and information pertaining to the article, accessing other articles (and questions or comments thereon), uploading answers to questions posted by others, commenting on articles, etc., and signing out.

A typical input that a publisher provides when submitting an article identified by an index i (where i can be a unique number associated with the article) comprises the article content Ci, analysis information such as a genre designation Gi of the article and a synopsis of the article and keywords from or about the article, a value Vi that the publisher proposes for the article, and an initial lifetime Ti that the journalist proposes for the article. System server 16 receives this information and subjects it to initial automated, computer-implemented processing. For example, based on information stored in the system and on rules applied by the operation of computer programs in system server 16, the system server sets an initial price Pi,o for access to the article, and may change the genre designation Gi and the keywords associated with the article, and may change the value Vi and the initial lifetime Ti that the journalist proposed to a higher or lower value and/or a shorter or longer lifetime. This process may involve automated delivery to the publisher's screen of information about the likely interest in the article and the likely revenue from access to the article, including information on likely current users who may be interested, likely future users, change in the number and geographical distribution of likely accesses to the article, likely changes in pricing access to the article over time or in relation to other factors, etc., to thereby help the publishers in the initial pricing and characterization of the article and possible revisions therein, and with respect to possible future articles.

Notably, in accordance with the improvement related to ratings, system server also calculates an initial rating parameter Ri,o, for example as a weighted combination of Pi,o, BOi,t for time t=0, and any previous rating of the author or publisher of the article. As explained below in connection with FIG. 1A, the rating calculation can involve additional factors, different weighting of factors, recalculations so that the Ri,t changes with time or with events, and separate ratings for an author, a publisher, and an article.

System server 16 electronically delivers the article and the processed information about it to a computer-implemented or computer-controlled articles database 18, which stores the information with the appropriate identification index i together with many other articles and the information associated with them. Each article can be designated as article Ai, where i=0, 1, 2, . . . , N, and N can be a very large positive integer. As one example, articles database 18 initially stores the article content Ci, the articles genre designation Gi, the article's price Pi (which at time t=0 may be the initial price Pi,o determined by system server 16 and possibly agreed to by the publisher), and the article's lifetime Ti. In addition, articles database 18 stores information about the state of the system, such as the current number BCi of users who have bought access to the article Ai (this number may be zero or a selected non-zero number before any access), and the number Bo of users who are on line in the system at time t=0. Articles database 18 updates BCi as users access the article, using information that is generated as discussed below in connection with the way publishers/users access articles. System server 16 can use information from article database 18 in automatically setting the initial price Pi,o for access to the article, for example by calculating Pi,o=Vi/Bo in a computer process, or by applying a more complex set of rules in a computer process to calculate Pi,o, which rules can take into account factors that the system stores or calculated through computer processes, such as history of the publisher, history of similar articles, the time and date of publication, the nature of the topic, etc.

In a specific example, articles database 18 electronically supplies, for each article Ai, the information Gi, Ti, Pi,t, and BCi,t to a computer-implemented or computer-controlled pricing application cluster 20 that, together with script server 22, forms a pricing engine. The first time information about an article Ai is supplied from article database server 18 to pricing application cluster 20, i.e., at time t=0, the parameter Pi,t=Pi,o, and the parameter BCi,t=0 (or some selected non-zero number), but at subsequent times t, BCi,t may be and typically is a growing non-zero number as more users access the article. The parameters for an article then iteratively pass in a computerized process, for each time t, from pricing application cluster 20 to articles database 18 and back to pricing application cluster 20. The time t can be periodic, e.g., every so many units of time, can be triggered by specified events, and/or can be reset to a new value at selected irregular intervals of time. In each iteration for time t, pricing application cluster 20 calculates through a computerized process an updated access pricing parameter Pi,t+1 (where the numeral 1 designates a time interval of 1 unit for article Ai, which time interval need not be a constant), and sends it back to articles database server 18, which will supply that price parameter as price Pi,t back to pricing application cluster 20 for the next iteration. Pi,t can be a single price for access, or plural different prices for respective different types of access.

Importantly, articles database 18, or another computerized system facility, stores historical information that can be useful for initial valuations of articles and/or initial selection of lifetimes of articles, and can be useful for other purposes as well such as, without limitation, system analysis and revising and improving scripts. This historical information can include, without limitation, information on the total numbers of users who have accessed articles, possibly classified by numbers of users who have accessed specific genres, topics and/or articles and are potential users of specific articles, possibly per geographical region and per language, and other historical information that has been automatically gathered in use of the system, and information that has been input by operators or administrators of the system in the belief that it may or should influence initial estimates of valuation and/or lifetime or can otherwise improve system operation and design.

Pricing application cluster 20 is a computer-implemented processing system that stores scripts Sj (where j is an index identifying a script, j=0, 1, 2 . . . , J, and J is a positive integer). Each script Sj is essentially a rule or a set of rules applied to information about articles that are being priced by pricing application cluster 20. Script server 22 is a programmed computerized facility that generates the script code via text or graphical editors, which may be under the control of system operators or administrators, manages the scripts, and assigns scripts to articles. In practice, one or more scripts Sj are assigned to each article Ai. Typically, plural scripts, and even a multiplicity of scripts, are assigned to each article. A script assigned to an article and used in pricing the article in pricing application server 20 can be updated by script server 22 so that the updated script will be used during the remaining lifetime of the article and possibly even after the lifetime of the article, unless further updated. Similarly, the assignment of scripts Sj to an article can be updated, so that pricing application cluster 20 applies different sets of scripts to the same article at different times.

Scripts Sj apply to articles Ai respective sets of rules that use as inputs a set or subset of factors and parameters that script server 22 has determined are useful in pricing access to articles. System server 16 collects and processes information regarding parameters from interactions with publishers 14 and users 10, and stores and updates that information in articles database 18 or another system facility, from where it can be supplied to pricing application cluster 20 and/or to script server 22 so that it may be used for each article Ai and each iteration for a time t. As illustrated in FIG. 1, these factors and parameters can include the following examples:

Bpi,t=number of potential purchasers of access to article Ai at time t;
BOi,t=number of potential purchasers of access to article Ai who are currently on line in the system;
BNi,t=number of remaining potential purchasers of access to article Ai (i.e., the potential purchasers who have not accessed the article);
Ri,t=accumulated rating of article Ai at time t (where the rating can be calculated based on factors such as, but not limited to, the rate at which the article is accessed compared to an average article or some other metric);
CTi,t=number of current potential purchasers of an article in a specified territory T (which can be a country or some other region) at time t;
PCi,t=price charged for access to article Ai at time t in a country C (or some other region), if different prices and/or prices in different currencies are charged for access from different parts of the world or through different access pathways or through different payment arrangements; and
BCi,t=number of users who have purchased access to article Ai by time t from a specified country or other region, or paid in a specified currency or through a specified financial arrangement.
Ri,t=accumulated rating, calculated for time t (which includes t=0, and t=1, 2, 3, . . . . N), for an author, a publisher, and/or an article identified by the index “i.”
RCi,t=accumulated rating at a time=t in a country or other area “C” for an author, a publisher, and/or an article identified by the index “i.”
CTi,t=the number of potential buyers of content that are online on the system at time “t” in a country or area “C” for an article identified by the index “i.”
PCi,t=access price to article “i” in a country or area “C” at a time “t.”
BCi,t=number of users who purchased an article “i” as of time “t” in a country or area “C.”

These are only examples of factors and parameters that can be taken into account in pricing access to an article, and any one implementation of the system and method described in this patent specification can use a subset of these values or a different set of values depending on the choice of the system implementers and the goals of the system.

Scripts Sj apply rules to articles Ai in a computer-implemented process to generate a price Pi,t+1 for article Ai in each iteration through pricing application cluster 20. As a simplified example, one rule can be that access price Pi,t+1 is set to ($0.03+Pi,t) if (i) the number BCi of users who purchased article Ai increased by 10 or more users from time t to time t+1 and also increased by 10 or more users in each time interval from t−10 to t, and (ii) the net number BNi,t of potential purchasers of access to article Ai increased by at least 5 users in each time interval from time t−20 to time t. It should be clear that any given example of implementation can include different rules depending on the designer's preferences and the goals of the implementation.

In a specific example, the system delivers content organized in channels each of which is a live, customized search that a user has chosen. The system matches that channel with articles and other information. A channel can be narrow or broad; for example, it can be based on keywords or specific publications. There can be pre-set channels and channels created in response to keywords from a user. The user can click on a channel and then on listings in the channel to gain access to an article and pay for access unless access is free at the time or to that user. Also, a user can subscribe to a publication or a collection of publications. There can be real-time users who pay more for faster access and/or access to all or some subset of all content, pay-per-view users who pay for access to a specified article, and free access users.

The improvement that this patent specification describes and illustrates as an example in FIG. 1A pertains to an enhancement that automatically freezes the access price related to a specific user and a specific article for a period of time before the user completes the purchase. If the time period expires, or if the user takes some specified action, the system can revert to its normal operation described above in connection with FIG. 1 and in more detail below in connection with FIGS. 2-32.

Referring to FIG. 1A, which illustrates an enhancement that operation in conjunction with and as incorporated in the system illustrated in FIG. 1, in step 21a a user selects an article from a listing on the user's screen, such as a listing similar to that illustrated in FIG. 2 and discussed further below. For example, the user highlights the screen entry for the article or a symbol associated with the article, or takes some other action that the system can interpret as the user's selection of an article.

In step 21b, the system (for example through a programmed operation of system server 16) interprets this user action as signifying that the access price to the selected article should be frozen for a time interval for that user. This can be an action by the user that is in addition to the action by which the user selected the article or simply the action of selecting the article. The additional action, if used in a particular implementation of the system, can be an action such as clicking on or touching a specified screen area, or holding down a mouse key, or some other positive action.

In an implementation in which the system requires an action in addition to the selection of the article to start a price freeze, if no such additional action is detected in step 21b for some time after the selection of the article, the system proceeds to step 21f to revert to the normal operation of the basis system, in which the price for the article changes with time dynamically.

If an additional action is detected in step 21b that the system interprets as indicating that a freeze should be imposed, the system proceeds to step 21c. In a system implementation in which there is no need for such an additional action by the user, and the simple act of selecting an article is interpreted as a request to freeze the access price, the system proceeds to step 21c without waiting for a further action from the user.

In step 21c the system freezes the access price for the selected article for that user. The freeze typically is only that for user and that article. However, in alternative implementations, the freeze can be for a class or group of articles and/or or a class or group of users. For example, if a user acts to freeze the price of an article on a given topic, the system may similarly freeze for some time the prices or closely related articles.

In step 21d the system checks whether the freeze period is over. The nature of this test depends on a particular implementation selected by the system implementers. Some examples are a test whether a set period of time has expired since the selection of the article in step 21a or from the action in step 21b, such as 15 seconds. Another test can be whether the access price determined by pricing application cluster 20 (FIG. 1) has changed in certain ways, for example whether it has increased by a set amount or a set percentage of the price at the start of the freeze period, so that the period can be longer if the price changes slowly or by small amounts of percentages. Alternative embodiments can use some other test designed to ensure that the user has a reasonable opportunity to make a purchasing decision and yet the freeze period is not too long and/or the price changes during the freeze period are not too great.

If step 21d determines that the freeze period is not over, the system checks in step 21e if the purchase of the article has been completed. Again, this can be implements through a programmed operation of system server 16.

If the answer in step 21d is YES, the system proceeds to step 21f to revert to normal operation. If the answer is NO, the system returns to step 21d to check if the freeze period continues or is over. As known in the art, suitable delays can be introduced between steps such as 21d and 21e to accommodate system requirements and the expectation of how quickly a user is likely to make a purchase decision after selecting an article.

The access price that was frozen as described above can be the price that the system determined at the time the user made the selection. Alternatively, it can be a price that is related to that price but may account for the delay in making the purchase decision. For example, it can be within a range of the price existing at the time of making the selection.

A more detailed description follows of certain aspects of the basic system improved through the incorporation therein of the facility described above relating automated rating of articles, authors, and/or publishers.

A specific implementation of many aspects of the basic system and method can rely on any number of scripts, and the scripts of one implementation may differ from those of another. Typically a large number of scripts would be used. Illustrated below is one example of a commented script of this type, in a computer language that a person skilled in the pertinent technology would understand and can code for use in a specific computer system:

Lua-script code sample

| Script code | | Script |
|---|---|---|
| If EQ_INIT == 1 then | | Initial execution of |
| | local price = eq_get_value( )/eq_get_pbuyers( ); | script for article |
| | | Initial price is equal |
| | | to Value divided by |
| | | Number of potential |
| | | buyers |
| | eq_set_price(price); | Setting of initial |
| | | price |
| | local p0 = (eq_get_purchases_delta( )/eq_get_pbuyers( ))*100 | Initial percent of |
| | | users who bought |
| | | article |
| | eq_save_number(“percent”,p0) | Save initial percent |
| | | of users who bought |
| | | article |
| | eq_next_call(0); | Scheduling of next |

| else | | script execution |
|---|---|---|
| | | (immediately) |
| | | Next script |
| | | executions |
| | if eq_get_execution( ) == 2 then | This code will be |

| | executed after 10 |
|---|---|
| | seconds of article |
| | processing (second |
| | execution) |
| local lp = eq_load_number(“percent”); | Load percent of |
| | users who bought |
| | article on previous |
| | script execution |
| local p = (eq_get_purchases_delta( )/eq_get_pbuyers( ))*100 | Current percent of |
| | users who bought |
| | article (BCi, t/ |
| | Bpi, t)*100% |
| if p − lp > 1 then | If number of users |

| | |
|---|---|
| eq_set_price(eq_get_price( )*1.2) | goes UP by 1% then |

| | |
|---|---|
| end; | Increase price by 20% |
| eq_save_number(“percent”,p) | Save current percent |

| | of buyers for using |
|---|---|
| | on next script |
| | execution |
| else | This code will be |
| if eq_get_execution( ) == 120 then | executed after 600 |
| | seconds of article |
| | processing |
| else | This code will be |
| | executed all next |
| | times |
| | Code! |
| end; | |
| eq_next_call(5); | Scheduling of next |

| | |
|---|---|
| | script execution |
| | (after 5 seconds) |
| end; | |

Pricing API description

One version of the script can support all functions in a table used for all countries (currencies), but other versions can support special arguments to allow set (get) values for specified countries.

For example:
eq_set_price(123, “Russia”); //Set price equal to 123 for Russia
local p=223;
eq_set_price(n,“France”); //Set price equal to 223 for France
local list={“USA”,“Germany”,“Japan”}
eq_set_price(149,list) //Set price equal to 149 for three countries
local pb=eq_get_pbuyers online(“Italy”) //Get number of online buyers from Italy

### API Description

| | Math | |
|---|---|---|
| Script functions | symbol | Description |
| eq_get_life_time( ) | Ti | Returns full article life time |
| | | in pricing engine(seconds) |
| eq_get_execution( ) | it | Index of script execution |
| eq_get_lived_time( ) | t | Returns time of article which |
| | | it lived in pricing engine |
| eq_get_value( ) | Vi | Return total value |
| eq_get_price( ) | Pi, t | Returns current article price |
| eq_get_trend( ) | Tdi, t | Returns current article trend |
| eq_get_genre( ) | Gi | Returns article genre |
| eq_get_pbuyers( ) | PBi, t | Returns total number of potential |
| | | buyers for article |
| eq_get_pbuyers_online( ) | POi, t | Returns total number of online |
| | | buyers |
| eq_get_article_rating( ) | Ri | Returns article rating |
| eq_get_purchases_total( ) | Bci, t | Returns total number of users |
| | | who bought the article |
| eq_get_purchases_delta( ) | BCi, t | Returns number of users who |
| | | bought the article since last |
| | | script execution |
| eq_save_number(name,val) | | Save some value (val) to |
| | | database with name |
| eq_load_number(name) | | Returns value from database |
| | | which is saved with name |

### Implemented Functions:

( )
eq_get_trend( )
eq_get_genre( )
eq_save_number(name,val)
eq_load_number(name)

Users 10, who are at remote user locations, access articles through a link with the system, for example through web link 11, in a manner similar to publishers (who can be users as well). As noted above, there can be different categories of users. Taking the example of a free user and one example of a link, the user signs on through a browser in a personal computer or other electronic device and through the Internet with system server 16, which sends to the user's screen a webpage that identifies the connection as one to a free user, and may include in the screen display at the user's screen information that identifies the user, provides a menu through which the use can upgrade status (e.g., to a pay-per-view user, by providing credit card or other financial information), may state that the articles are delayed by a specified time interval, may provide a listing of active channels (topics), may provide a filter menu through which the user can create new active channels (e.g. by submitting a search query), may list available articles in the channel that the user designates and the status of each article (e.g. as free, or available for a listed price or by subscription only), and may provide many other items of information to the user.

FIG. 2 illustrates one example of a webpage that the system can provide on the screen of a pay-per-view (PPV) user. There can be other examples, and different presentations have been and are being evaluated in the course of developing the basic system and the improvement related to automated ratings. The upper left identifies the category of user (“PPV”) and has a menu item “upgrade” through which the user can upgrade to a different category (e.g., by specifying the desired category and providing credit card information or making other financial arrangements). Through clicking the left column entries, the user can select: Top Stories, in which case the right columns will show a selection of several stories that are the most popular ones at the time; or My Master Channel, in which case the system will list one or more channels that the user has previously selected; Active Channels, in which case the system will list on the left several active channels as in the illustrated example. Each active channel shows the number of articles that user has not yet read (in this example, the Apple channel has 2 unread articles and the Clinton channel has 18 unread articles). The same number of unread articles shows in upper right when the respective channel (Apple [AAPL] in this example) is selected and when it is updated, and the color of the number is changed when the system posts another article in that channel. To the left of the active channel names are symbols that identify the source of the material, for example Q for the system described in this application and AP for Associated Press (in this example, a publisher such as AP can supply content to the system and method described in this patent specification per financial and/or other arrangements made between AP and the system).

To the right of the channels are an identification of the channel that is currently selected (Apple [AAPL] in this example) and a scrollable listing of articles in that channel, by title and/or synopsis. The circled symbols to the left of each article title identify the genre designation of the article (e.g., BN for breaking news) and the source of the article (by an abbreviation such as AP for Associated Press, a picture of the author, and/or in some other way). To the right of the article name is information on access rights and on the trend of access. For example, access to the first listed article in FIG. 2 costs $0.35 at the time the page of FIG. 2 is the current version that is being displayed to a user, and the trend is up (i.e., there is increasing interest in the article as pricing application cluster 20 has determined based on current requests for access to the article and/or other factors related to the popularity of the article which system server 16 has tracked). If a “Free” user decides to access this priced article, the user may upgrade status by clicking on “Upgrade” at upper left and proceed through the menu that would appear on the user's screen in response. One article has an arrow that points up at an angle, to indicate a lesser degree of increasing popularity. Comparable arrows that point down indicate different degrees of decrease in popularity of the respective articles. Some articles are identified as “SUB,” meaning that they are available under subscription. FIG. 2 does not happen to illustrate free articles that would be identified by the notation “Free” to the right of the article title.

If the user clicks on an article, system server 16 obtains it from articles database server 18 and downloads it to the user's screen. At upper right are buttons for scrolling, enlarging, hiding, and other operations on the articles. When the portion of the display to the right is detached from the channel listing and moved some distance to the right of the channel listing, there are scroll bars to the right of each portion. When the user clicks on an article, the color changes and a synopsis of the article may be included in the area that is so colored. The titles of articles that the user has already read may be colored differently from other article titles. The lines for breaking news may be highlighted in yet another color.

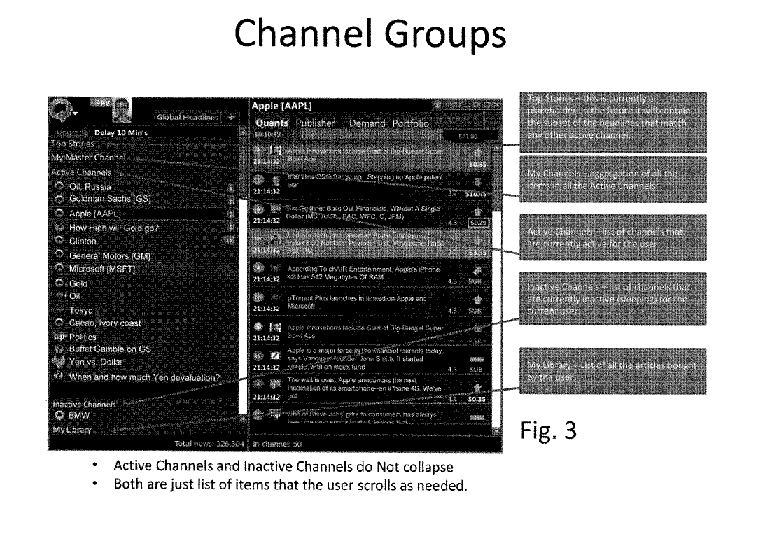

FIG. 3 illustrates an example of a screen with various channel groups that the system downloads to a pay-per-view (PPV) user. It is similar in many respects to a Free user interface, identifies the user as a PPV user, and may include the user's picture. In addition to the illustrated active channels, it can include inactive (sleeping) channels. The PPV user can click on the price entry for an article to open the article, in response to which system server 16 download the article to the user and the text of the article is displayed on the user's screen in a new window in the same manner as discussed above or as discussed below for “real time” or “subscription” users. System server 16, of another facility of the system, charges the PPV user's account, or a user's credit card that the user has identified to the system for that purpose, for this download and stores the charge information in the system, for example in articles database server 18. As in the case of other categories of users, the PPV user can create a new active channel by entering a search term or query in the box labeled “filter.” The PPV users are charged for access to some articles. For example, the user can make arrangements with the system to allow charging the user's credit card for the price of an accessed article, or the user can make a deposit into the system through a credit card or otherwise, in which case the card or the deposit is charged accordingly. Charging systems are known in the pertinent technology and, for the sake of conciseness, are not discussed in detail in this patent specification.

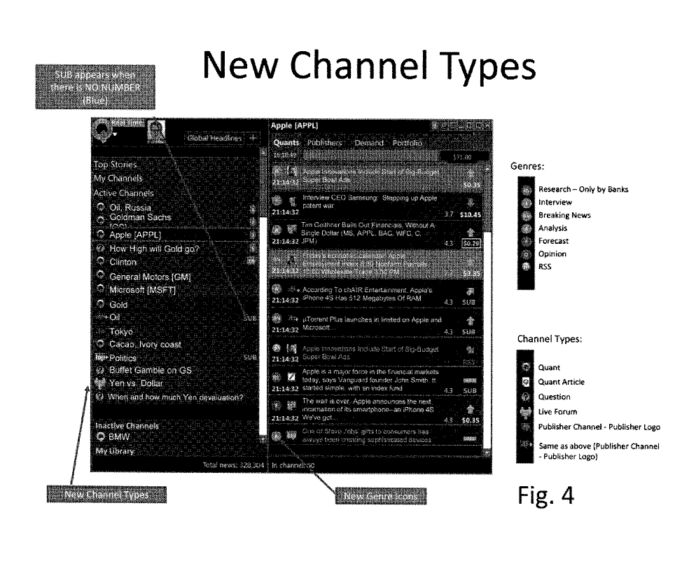

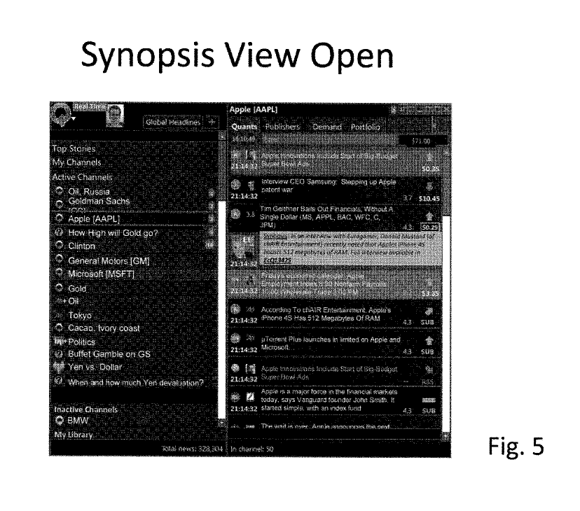

FIG. 4 illustrates an example of a screen that the system downloads to a real time user. Again, it is similar in many respects to a Free of PPV interface but identifies the user as a real time user and may show a picture of the user at upper left. As noted above, the real time user can have a greater number of active and/or inactive channels and, as in the case of the PPV user, can post questions and comments on the articles. Questions and comments, and answers to the questions that the publisher of the article may provide are visible to all user categories, or only to some of the categories, as determined by pricing application cluster 20. A real time user gains access to article content in a manner similar to that used for a PPV user except that a real time user has access to all articles without delay and does not pay for individual articles (including those for which a price is indicated) from a particular publisher where the real time user has previously paid for a subscription. FIG. 4 also illustrates the genre symbols and channel type symbols and meanings attached to them. FIG. 5 illustrates an example of a synopsis view of an article that opens on a user's screen in response to a user moving a cursor over the article title or clicking for a synopsis view. Again, because systems for making financial arrangements with subscription users are known in the pertinent technology, such as for web access to newspapers, magazines, and data services, a suitable method for charging subscription users need not be discussed in detail.

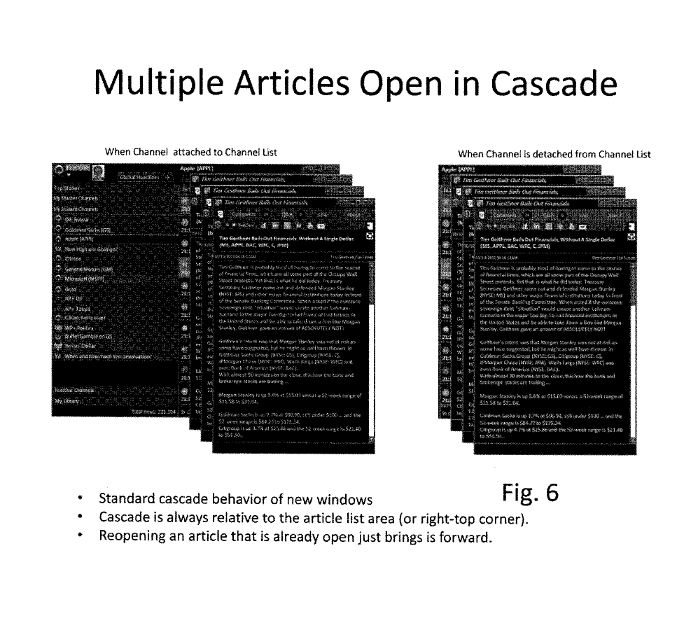

FIG. 6 illustrates a cascade of articles that a user has opened (accessed). If only one article is opened, then of course only one article would appear on the user's screen next to or detached from the channel listing. A horizontal middle band or other portions of the FIG. 6 screen may be deleted in order to make the remaining text more legible.

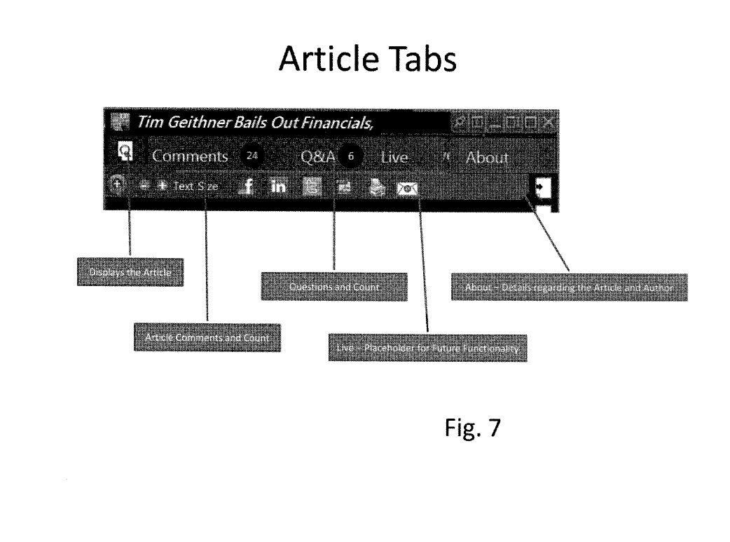

FIG. 7 shows in magnification article tabs that appear in the display of an open article seen in FIG. 6. In FIG. 7 the display of an open article includes a tab Q for displaying the article, a Comments tab for displaying comments about the article that PPV and real time users have posted (24 comments in this example), a Q&A tab for displaying questions about the article (6 in this example), a Live button for a function such as live chat, and an About tab for the display of details regarding the article and/or its publisher.

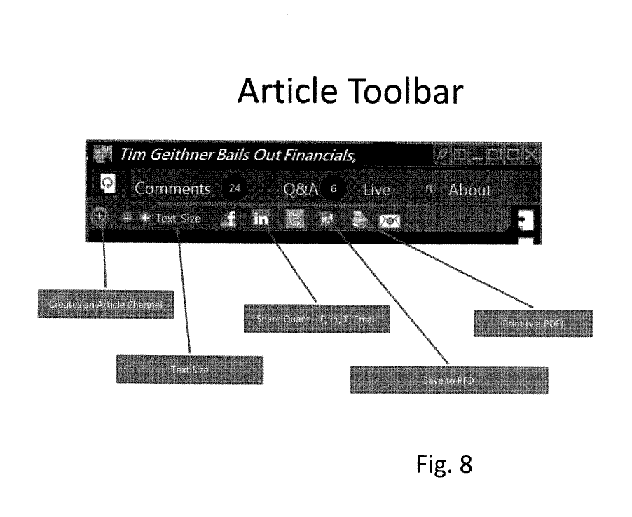

FIG. 8 illustrates an example of another magnified portion of the FIG. 6 display. As seen in FIG. 8, the display of an open article includes a “+” button that creates an active channel for the user, which active channel is the topic of the article. Buttons labeled “−” and “+” next to the label “text size” enlarge or reduce the text size. Several buttons to the right when activated by the user export the article, such as to a Facebook account, a Twitter account, a LinkedIn account, etc. Another button saves the article in the user's computer or other device, in a desired format such as in text format or in PDF format. A print button prints the article, for example in text format or in PDF format. Another button activates an email function for emailing the article to one or more specified addresses.

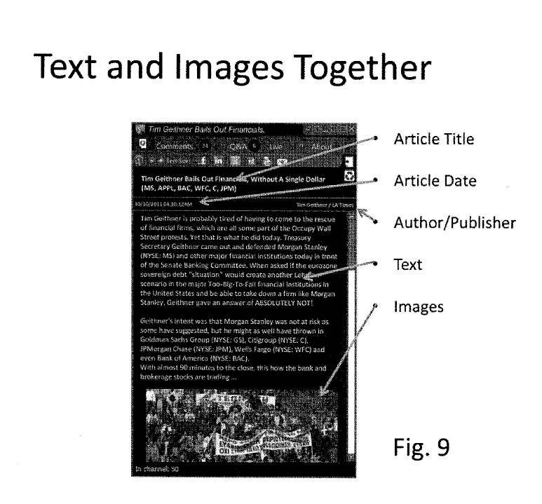

FIG. 9 illustrates an example where an article includes not only text but also images.

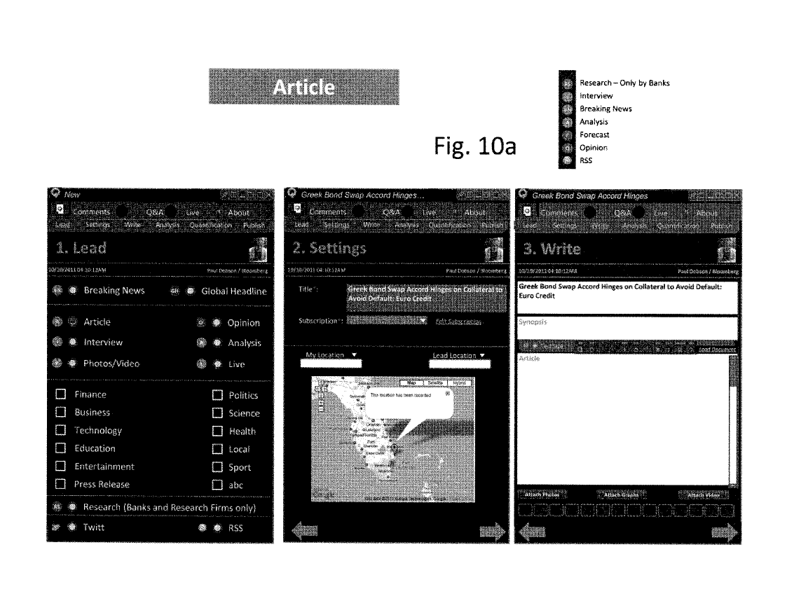

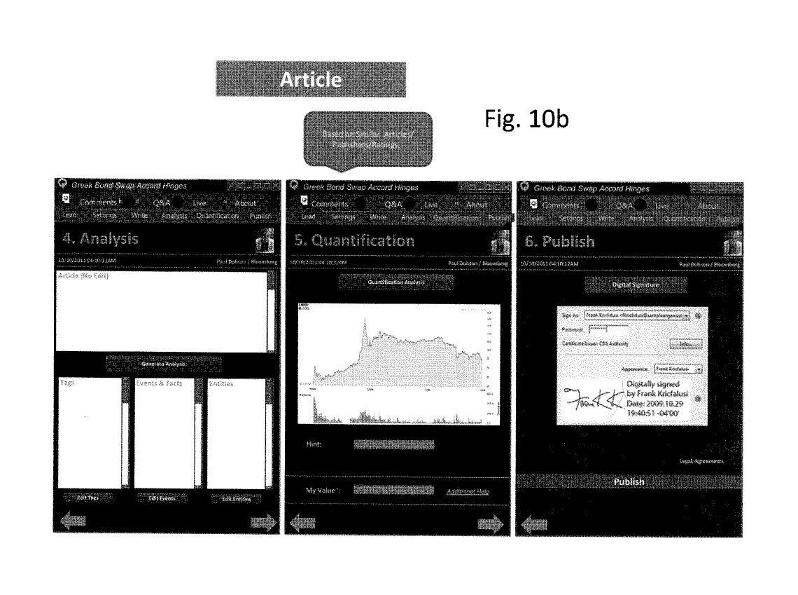

FIGS. 10a and 10b illustrate self-explanatory interactions of a publisher with the system, through which the publisher signs on and provides the system with an article and the information regarding the article as discussed above. As one example, in the screen at the left of FIG. 10a, which contains the heading “1. Lead,” the publisher may enter initial information about the article by checking the appropriate entries, e.g., to indicate that the article is “Breaking News,” its genre designation is “Opinion,” and it pertains to “Finance.” In the next screen, which contains the heading “2. Settings,” the publisher can enter additional information such as a title of the article and the publisher's location. In the next screen which contains the heading “3. Write,” the publisher writes in a synopsis of the article (if desired) and the text of the actual article, and attaches any photos, video or other material as indicated. FIG. 10b, the next screen, contains the heading “4. Analysis,” where the publisher can enter further information about the article, for example, key words or tags. The middle screen contains the heading “5. Quantification,” informs the publisher about the system's estimates of revenue from users' access to similar articles over a specified time interval, and prompts the publisher to assign a proposed money value to the article. The last screen that the system places on the publisher's screen display contains the heading “6. Publish” and provides the system with an authentication of the publisher and the publisher's agreement with the system's terms regarding posting and using the article. Additional facilities can be provided to allow publishers (who also may be users) to view information regarding questions and to post answers, which information may treat answers and potential answers in a way similar to the treatment of articles and potential articles.

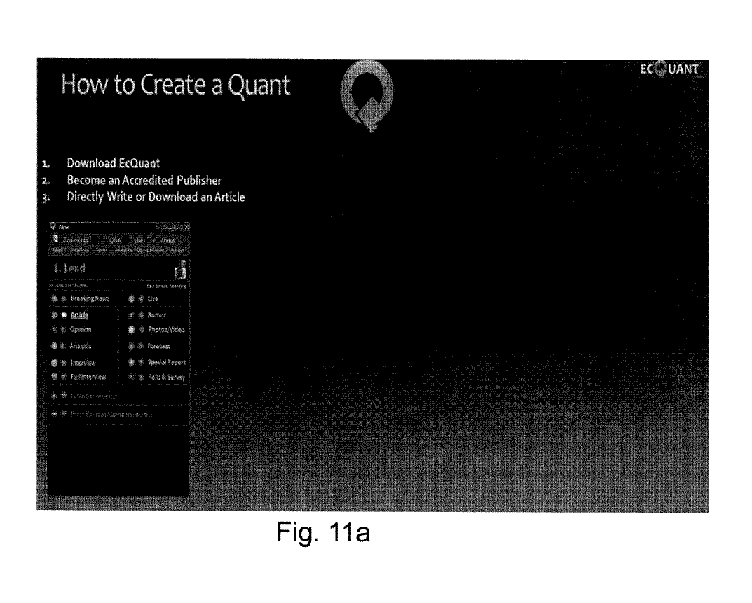

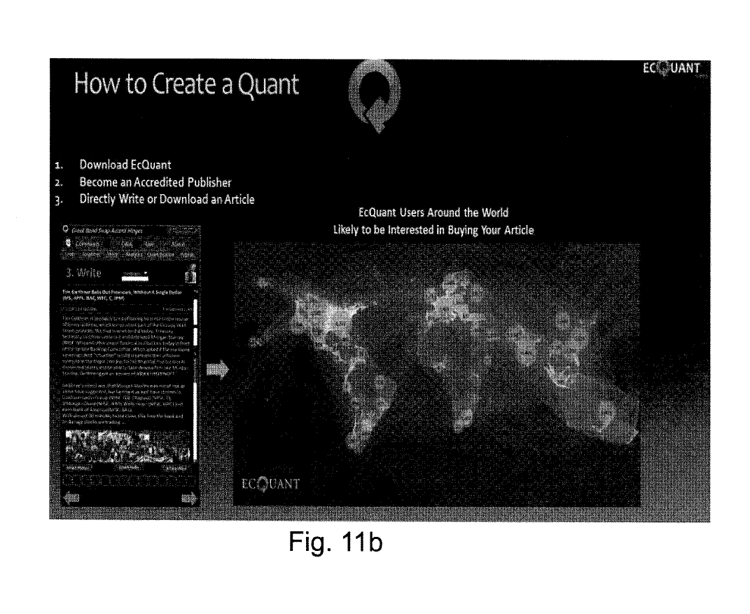

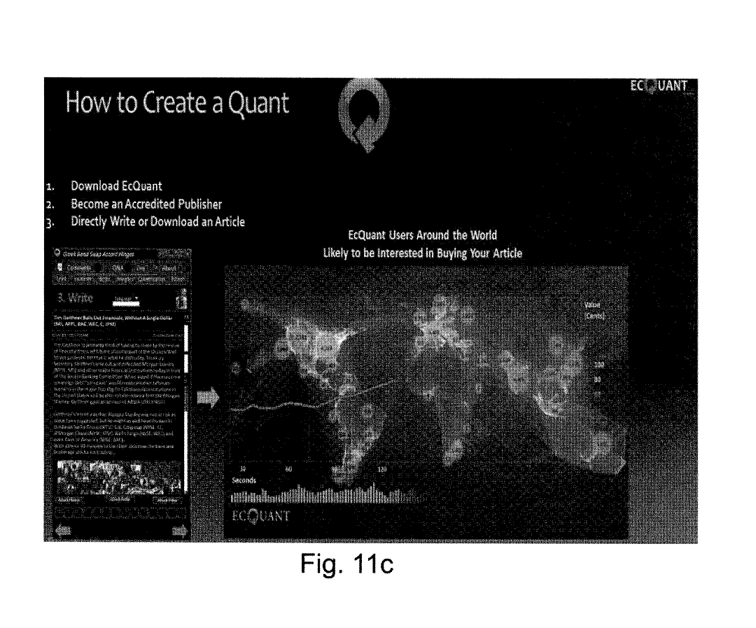

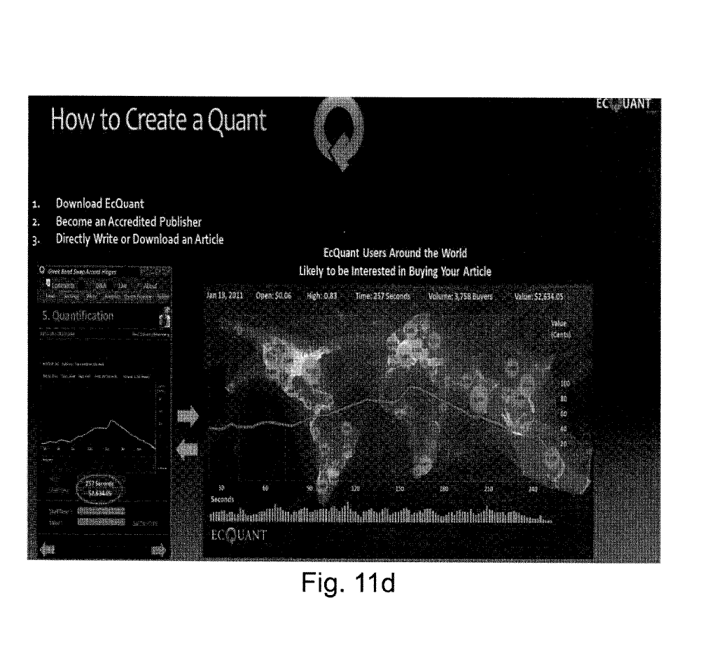

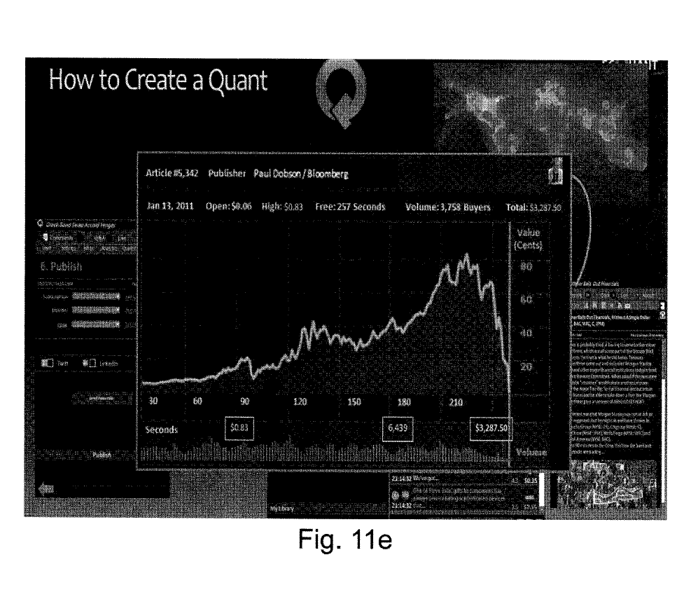

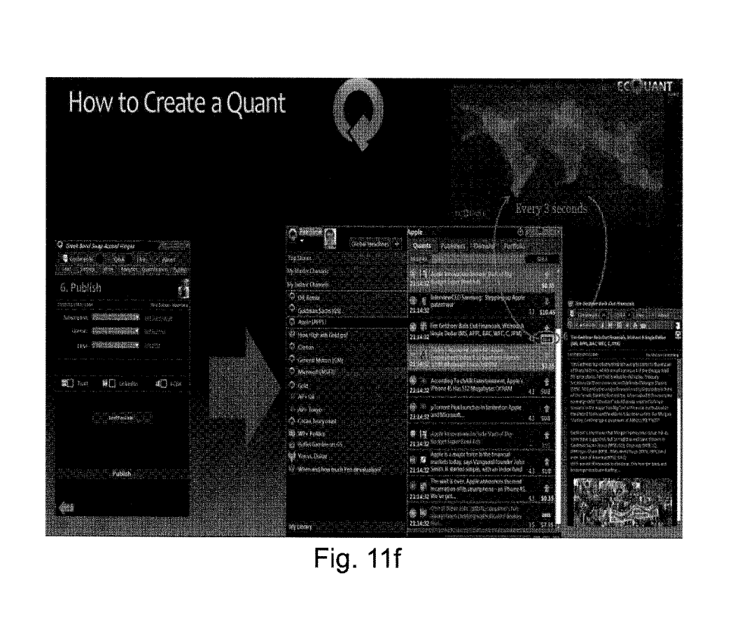

FIGS. 11a through 11f illustrate another example of interaction between a publisher and the system. FIG. 11a illustrates that a publisher can start the process by (1) downloading a program called “EcQuant” from the system, (2) entering suitable information for becoming an accredited publisher, such as identity and perhaps credentials information and information regarding financial arrangements with the system, and (3) writing articles for posting by the system or downloading (accessing) articles from the system. FIG. 11b illustrates a screen that the system may download to a publisher's screen after the publisher has submitted an article (which in this case has an attached photo) to the system. To the right of the article, the screen contains a stylized world map over which the system displays for the publisher the number of potential users who may be interested in accessing the article, by territory. For example, there are 4,237 potential users in the U.S. East. The system generates this information about potential users by analyzing the article and its attributes and by using historical information about past behavior of users, through the use of scripts that act as a computer-implemented expert system operating in the pricing engine of the system described in this patent specification. It will be appreciated that as the system grows and adds more publishers and articles, and gains more experience with actual usage of the articles, its estimates of potential users are likely to become more accurate or at least more useful as the scripts are refined based on experience and as more historical information on user behavior is assembled. A display such as illustrated in FIG. 11b may help the publisher make an initial decision of an initial value to place on the article. FIG. 11c illustrates how the price for access to the article may vary over time as the system resets it from time to time through the pricing engine. The horizontal axis is time in the graphs in the right-hand portion of FIG. 11c. The vertical axis for the red line is the changing access price, in this case in the range of about $0.40 to about $0.80 over a time interval of about 130 seconds after the posting of the article. The green bars at the bottom illustrate the instantaneous number of users accessing the article. FIG. 11d is similar but pertains to a later time—257 seconds after the article was posted. The graphs in this example show that the price for access to the article peaked about 160 seconds after posting and then declined until it went down to less than $0.20 as the number of users accessing the article declined. FIG. 11d also shows that in this example the cumulative revenue from the article over this time period was over $2,600. FIG. 11e illustrates similar information, in a somewhat different format and for different access prices and a different cumulative revenue from an article, but similarly indicating that the system described in this patent specification changes access prices over time as a function of user behavior in a manner that is believed to reflect the actual values that users place on access to the article. FIG. 11f illustrates a relationship between a screen display that a publisher may see (the left-hand portion of FIG. 11f) and a screen that a user may see. The user's screen shows a listing of channels (topics) in the left column, a listing of articles in the middle column, including an article for which the access price changes every 3 seconds in this example. If an improvement related to priced access to answers is implemented, the system can treat answers and potential answers in the manner explained for articles.

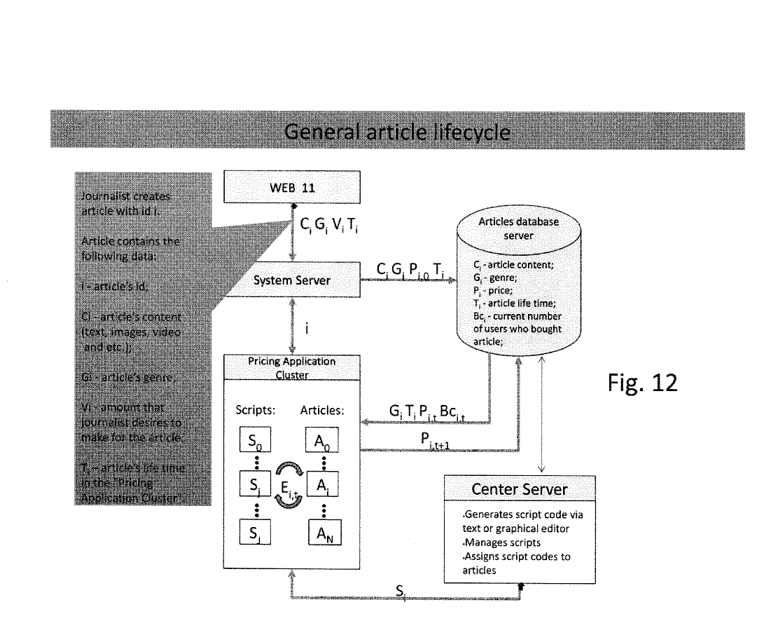

Returning now to the overall operation of the system and method, FIG. 12 illustrates a portion of the system of FIG. 1 (but does not repeat the reference numbers for identically named components of the system), and in the box on the left identifies an example of the information that a publisher such as a journalist provides to the system through the web page that the system downloads to the user's screen.

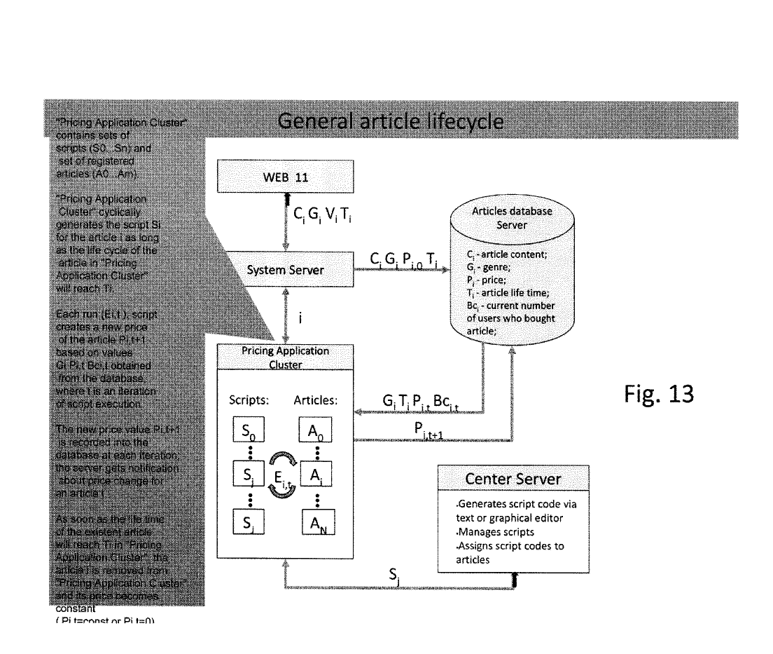

FIG. 13 illustrates the same portion of the system as FIG. 10 but in a different stage of processing the pricing of the article, and in a box on the left illustrates a simple example of factors and parameters that go into the pricing process.

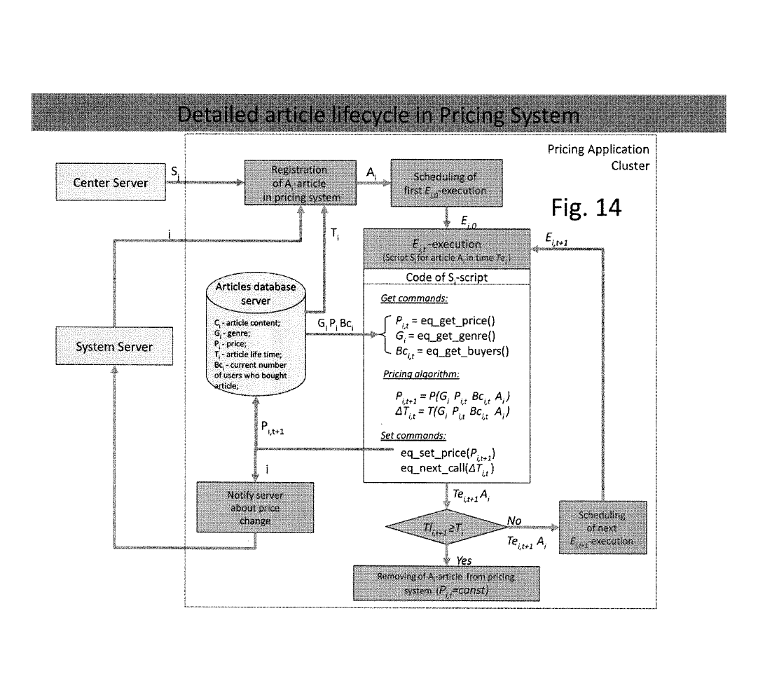

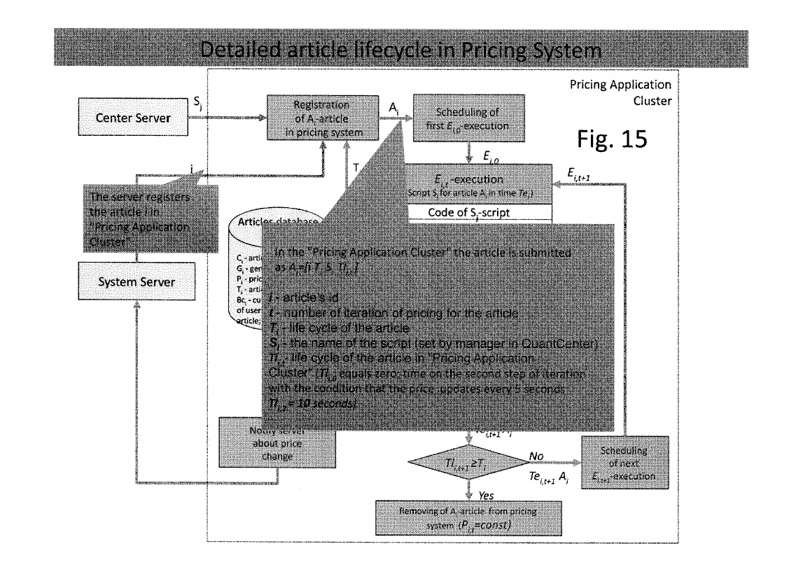

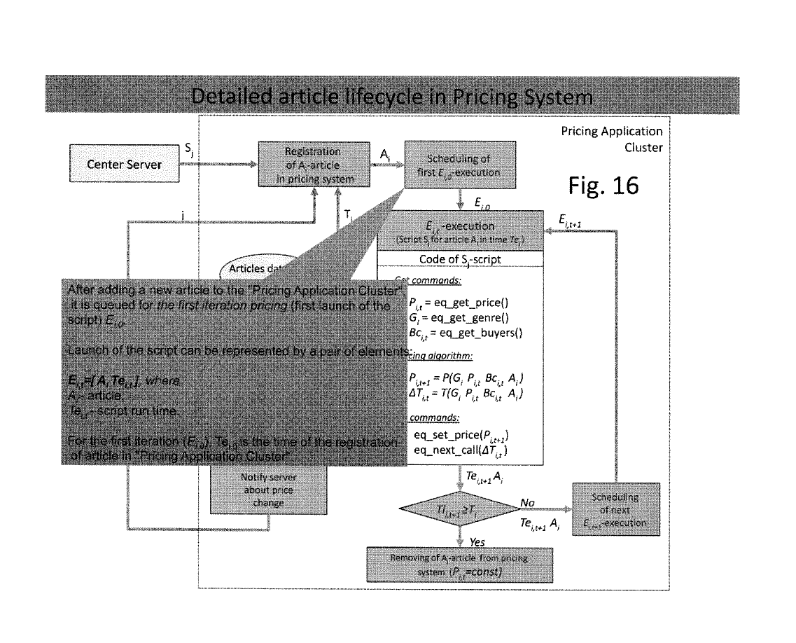

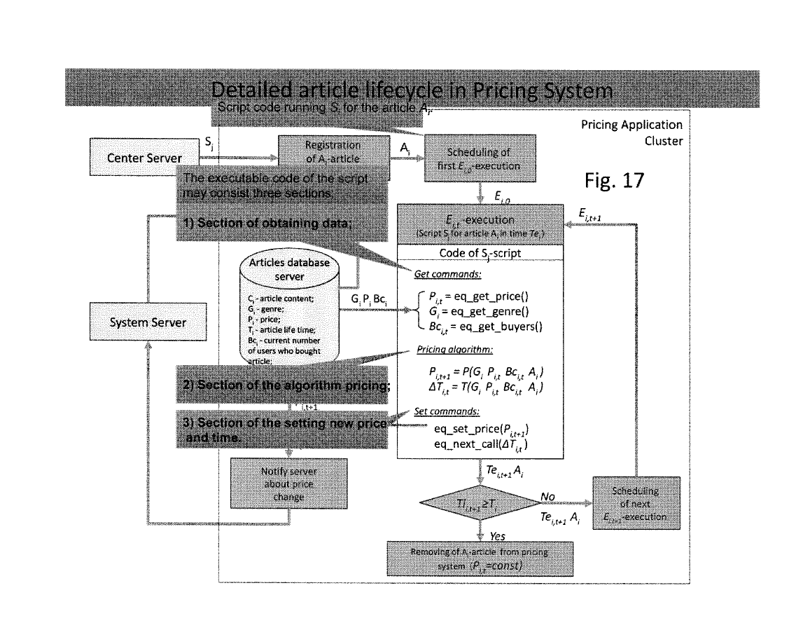

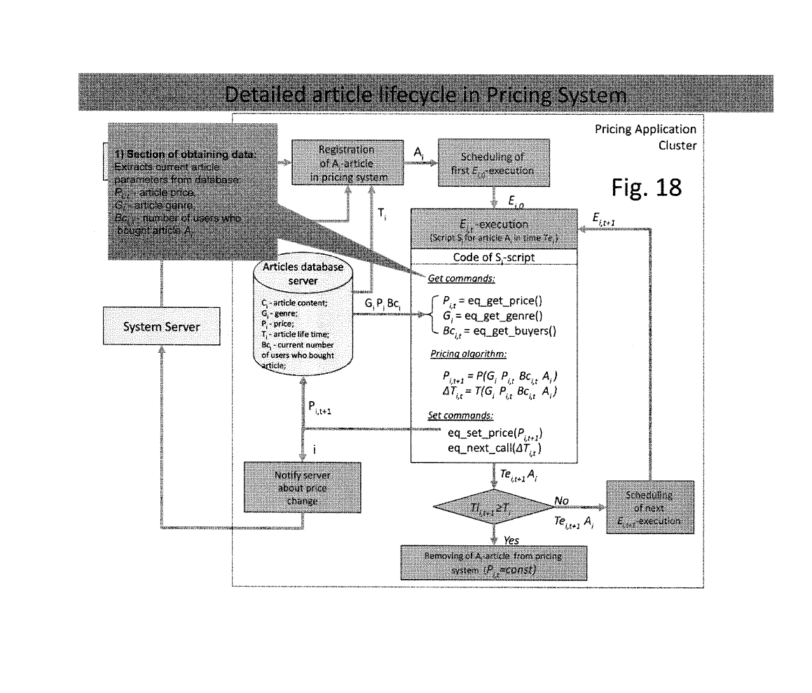

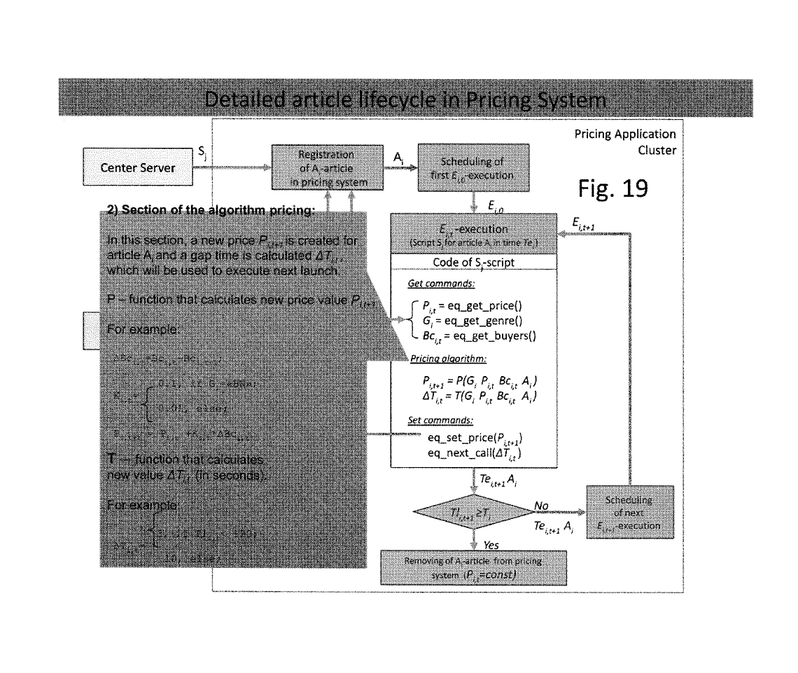

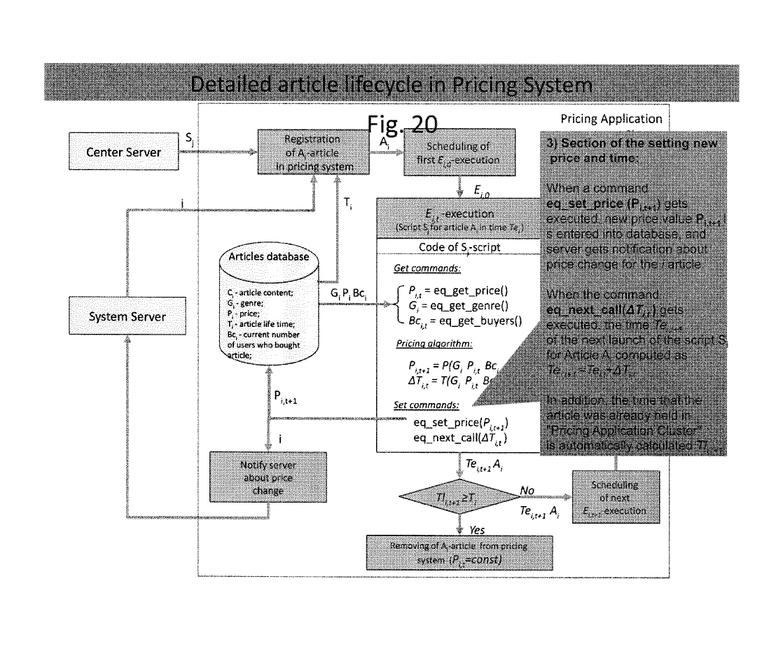

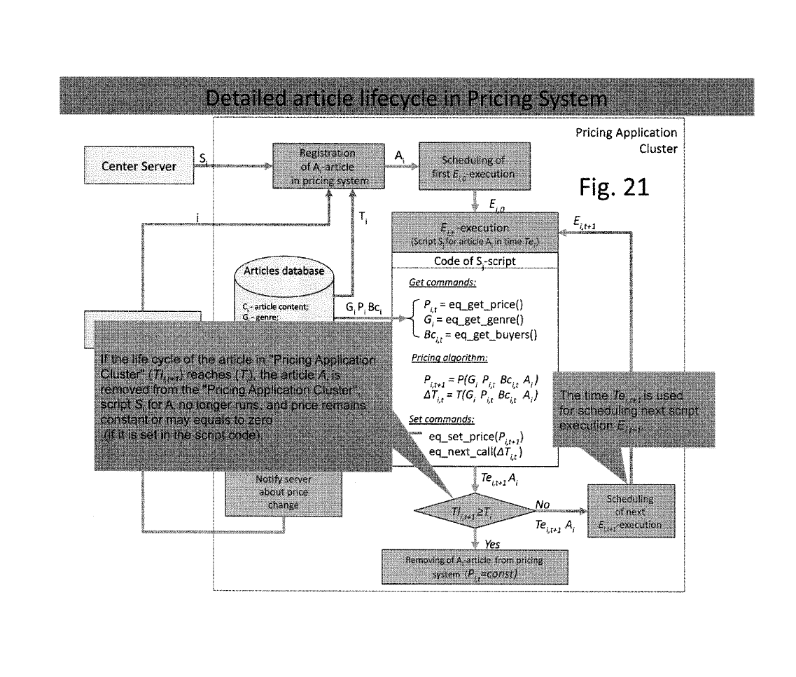

FIGS. 14-21 are self-explanatory examples of different stages of the process of pricing access to an article in flowchart format and further illustrate examples of process steps involved in pricing and re-pricing access to articles. Thus, FIG. 14 illustrates in more detail a lifecycle of an article in the pricing system. In this example pricing application cluster 20 and center server 22 interact with system server 16 and articles database server 18. As illustrated, center server 22 provides one or more scripts Sj that are associated with an article Ai in the step labeled “Registration of Ai-article in pricing system.” System server 16 provides an identifying index and article database server 18 provides a time Ti value. Upon scheduling a first execution Ei,o of the script(s) for article Ai, the step labeled “Ei,t-execution” applies the indicated script commands to the parameters that article database server 18 provides (GiPiBci), executes the indicated pricing algorithm commands and set commands, and provides articles database server 18 with updated access price values Pi,t+1 that would be provided to the step “Ei,t-execution” for the next iteration that corresponds to time (t+1). The updated price (or a price change) Pi,p+1 also is supplied to system server 16 as indicated so that subsequent users will be charged accordingly for access to article Ai. The indicated test whether the lifetime of the article has expired leads to another cycle through pricing if the article's lifetime has not expired, or to removing the article from the pricing system if its lifetime has expired (in which case access to the article may be offered to users at no charge, or access to the article can end, or some other step may be taken depending on preferences of a designer of the overall system). FIG. 15 is similar except that it shows in more detail, in two callouts, that system server 16 helps register article Ai in the pricing application cluster, and that the article is treated in the pricing application cluster under the designations Ai=[I Ti Si Tli,t]. The larger callout also defines the symbols used in the expression for Ai, and gives a non-limiting example of time increments for iterations through the pricing cluster. FIG. 16 also is similar, and includes another callout detailing how article Ai is provided to the pricing cluster and how the first execution Ei,o is launched. FIG. 17 also is similar but includes different callouts detailing that a non-limiting example of an executable code for a script may comprise a section for obtaining data, a section for algorithmic pricing, and a section for setting a new price for access to the article and a new time. In each case, the callouts point to the appropriate examples of script commands. FIG. 18 also is similar but in this case the callout provides more detail regarding the section for obtaining data for article Ai and includes definitions of terms used in the section. FIG. 19 has the same background structure but the callout provides more detail about the section for algorithmic pricing and sets out and explains specific non-limiting examples of a function P that calculates a new price Pi,t+1 for a user's access to an article Ai. FIG. 20 has the same background structure but the callout in this case provides more detail about the section for setting new prices and explains specific non-limiting examples. FIG. 21 also is similar in terms of the background structure but in this case the callouts specify the time value that is used for scheduling the next cycle (the next execution Ei,t+1) of the illustrated example of a script for article Ai, and explain a non-limiting example of how to price access to article Ai when its lifetime has expired. The system can treat priced access to answers in an analogous manner.

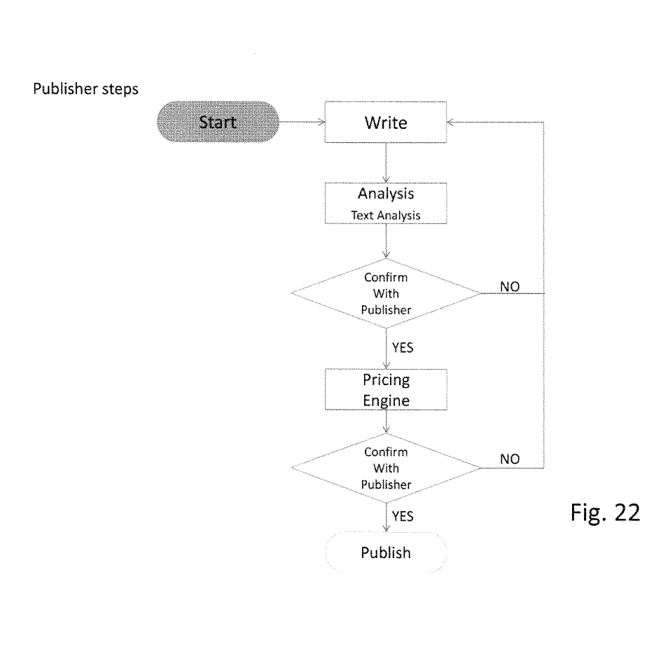

FIG. 22 is a flowchart illustrating an example of some of the steps in an interaction between a publisher and the system. Following the step labeled Start, in which some of the interactions that were described above take place, in the step labeled Write the publisher submits the article and initial information such as keywords. In the step labeled Analysis, the system carries out text analysis and other processing of the submitted article and sends back to the publisher's screen the resulting output, possibly changes keywords and other information about the article. In the test labeled Confirm With Publisher the system checks whether the publisher has confirmed these changes. If the answer is NO, the system iterates until it has received confirmation from the publisher at this stage, and the answer in the test is YES. In the step labeled Pricing Engine, the pricing engine described above applies scripts and generates pricing information, which also is sent back to the publisher's screen so that another test labeled Confirm With Publisher can be carried out, possibly with iterations until the answer in this second test is YES, and the system can proceed with posting (publishing) the article. The principle apply to providing an answer for priced access.

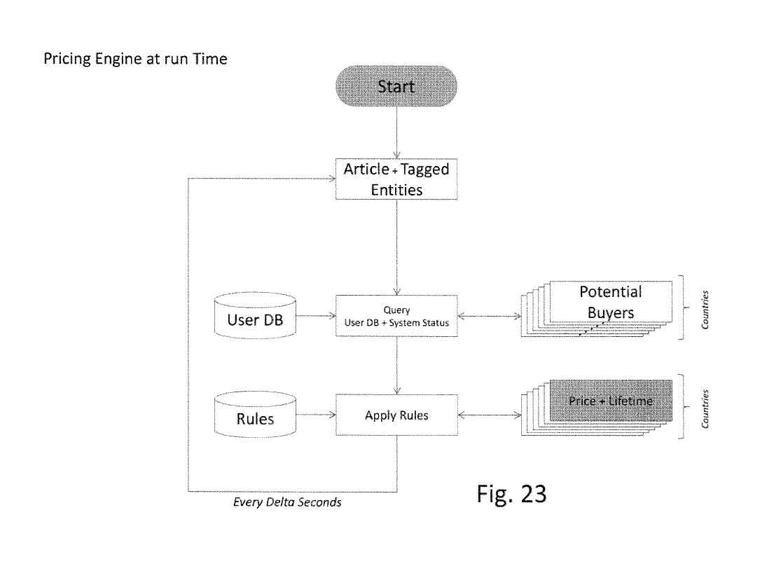

FIG. 23 is a flowchart illustrating an example of steps in the operation of a pricing engine, and follows the process of FIG. 22. Following preliminary operations in the step labeled Start, in the step labeled Article+Tagged Entities the system stores the article that the publisher has submitted as well as information about the article, such as the initial value assigned to the article, keywords, genre, etc. (collectively called Tagged Entities in FIG. 23). In the step labeled Query, the pricing engine collects the information pertaining to the article to which scripts will be applied, for example from the storage labeled User DB, and also collects information regarding Potential Buyers (i.e., users), and supplies this information to the step labeled Apply Rules, where scripts of the type discussed above are applied in order to generate current prices for access to the article. This application of scripts uses information from a source labeled Rules (which is a source of scripts) and information labeled Price+Lifetime. At time intervals labeled Every Delta Seconds, the system sends updated prices (or an updated single price) back to the step labeled Article+Tagged Entities, where the updated pricing information is stored for use in the next iteration through the process illustrated in FIG. 23. The principles apply to priced access to answers.

The pricing engine can be configured to calculate and direct payments to publishers in compensation for articles and answers. The calculation can be based on factors such as a share of the cumulative revenue that the system derives from an article or answer provided to users, on the nature and history of a relationship between the system and the publisher, and/or other business factors. The calculation can also account for benefits that the system provides to publishers. For example, the system can be configured to post promotional material such as advertisements from publisher and attach such promotional material to the articles or answers delivered to users and/or to other content provided by the system, in which case some or all of the compensation that the pricing engine calculates for a publisher can be based on the promotional material benefits to the publisher. As a non-limiting example, the system may allow a publisher to post advertising or other material to the system, for display to users or others, on terms that would reduce or eliminate payment in funds to a publisher.

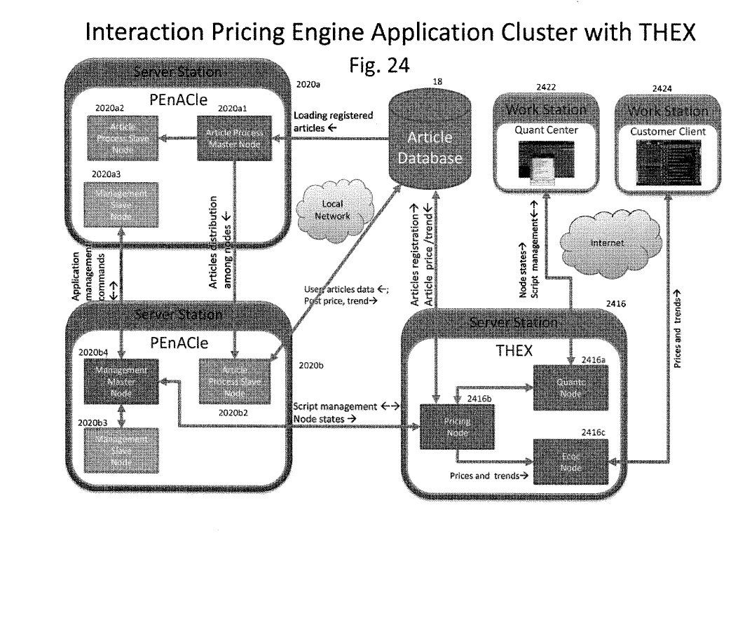

FIGS. 24-32 illustrate an example of pricing users' access to articles, it being understood that this is only one of several possible ways of constructing and using a pricing engine consistent with the principles disclosed in this patent specification, and that the illustrated functions can be carried out in equipment that is not physically adjacent but selectively exchanges information over links such as the Internet, dedicated or shared optical and/or electrical lines, or in some other way, and that two or more of the indicated functions may be carried out by the same piece of equipment or one of the indicated functions may be carried out by two or more pieces of equipment.

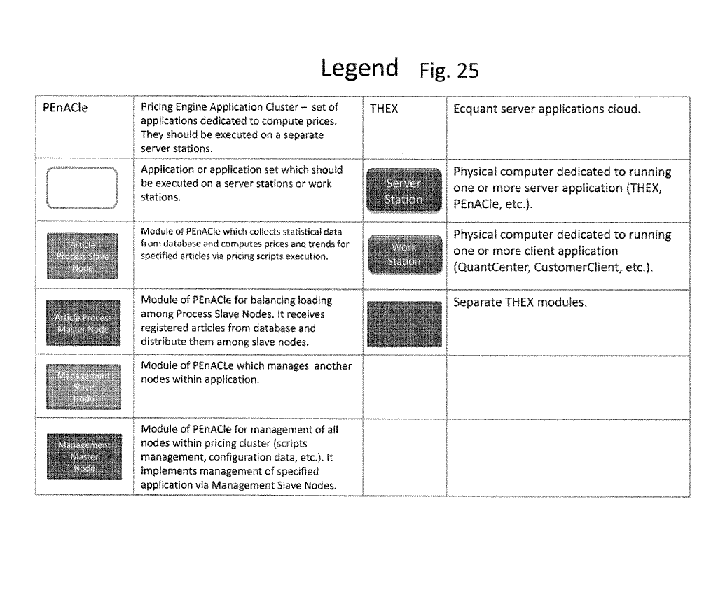

As illustrated in FIG. 24 and further explained in FIG. 25, an article database server 18 described above interacts with the pricing engine. In the example of FIG. 24, a pricing engine application cluster (PEnACle) comprises two PEnACle units 2020a and 2020b but can include additional similar units that together perform functions similar to those of pricing application cluster 20 in FIG. 1, i.e., apply scripts to articles to generate initial and subsequent pricing for access to the articles. PEnACle 2020a comprises an article process master node 2020a1 that receives, from article database server 18, articles Al and information about the articles that have been provided to (registered in) server 18, and distributes the received information to article process slave nodes such as 2020a2 and 2020b2 for processing, for example in a manner that reasonably equalizes the processing loads of the slave nodes. Slave node 2020b2 can also communicate directly with server 18. The article processing slave nodes apply scripts to the articles and other information received from database 18 to calculate initial and updated prices consistent with the pricing principles discussed above. One of the PEnACle units contains a management master node, 2020b4 in this example, that is connected with management slave nodes such as 202a3 and 2020b3 that can be in each PEnACle unit, to carry out management of all nodes within the pricing cluster such as script management, configuration management, etc., and to implement such management via management slave nodes such as 2020a3 and 2020b3. Management master mode 2020b4 and server 18 communicate with a server application cloud THEX 2416 that performs functions similar to those of system server 16 in FIG. 1. THEX 2416 comprises a Quantc node 2416a that communicates with a workstation 2422 performing functions such as tracking and controlling node states and providing overall management of scripts, and a pricing node 2516b that communicates with server 18 to keep track of and receive and return information such as articles registration information, article access prices and price trends, and with management master node 2020b4 and Quantc node 2416a to exchange information about node states and script management. In addition, pricing node 2416b communicates with node 2416c, which is labeled Ecqc in FIG. 24, to provide price information and information about trends in access prices, as to which node 2416c communicates with a workstation 2424 that can track the price and trend information. The principles apply to pricing access to answers as well.

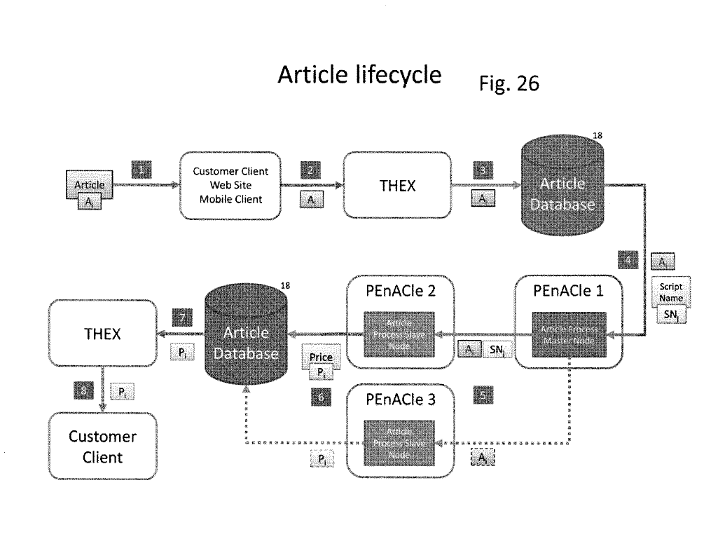

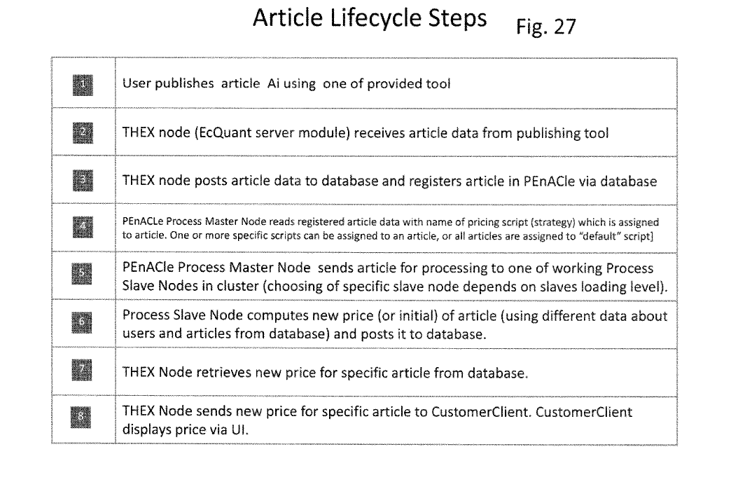

FIG. 26 illustrates steps in the process of pricing access to articles in the operation of the pricing engine of FIG. 24 and according to the further explanation that FIGS. 25 and 27 provide. As illustrated in FIG. 26, in step 1 a publisher provides (publishes) an article Ai through an interaction of a publisher 14 via a link such as the Internet with the THEX unit in FIG. 24. In step 2 the THEX unit performs a function similar to that of system server 16 of FIG. 1 to receive the article and associated information from the publisher. In step 3, the THEX unit supplies (posts) the article to database server 18 and registers the article in the PEnACle units via database server 18. In step 4, the article process master node 2020a1 receives the article information and the script(s) associated with the article. In a simplified example, there can be a single default script that would be applied to each article, or there can be respective default scripts that are applied to different groups or classes of articles. In step 5 master node 2020a1 sends the article and related information for processing in an article process slave node such as nodes 202a2 and 2020b2 (or to another node if there are more than two PEnACle units, selecting a particular slave node depending on processing load distribution factors. In step 6 the slave node that received the information computes an initial or an updated access price for the article using the script application principles discussed above and provides (posts) the computed price to database server 18. As discussed above, the access price for an article typically varies over time and there can be different prices for different users or classes or users or kinds of access. In step 7 the THEX unit receives the initial or updated price of access to article Ai from database server 18, and in step 8 the THEX unit provides the price and related information (such as trend and/or other statistical information) to users 10 and/or workstation 2424. The principles apply to pricing access to answers as well.

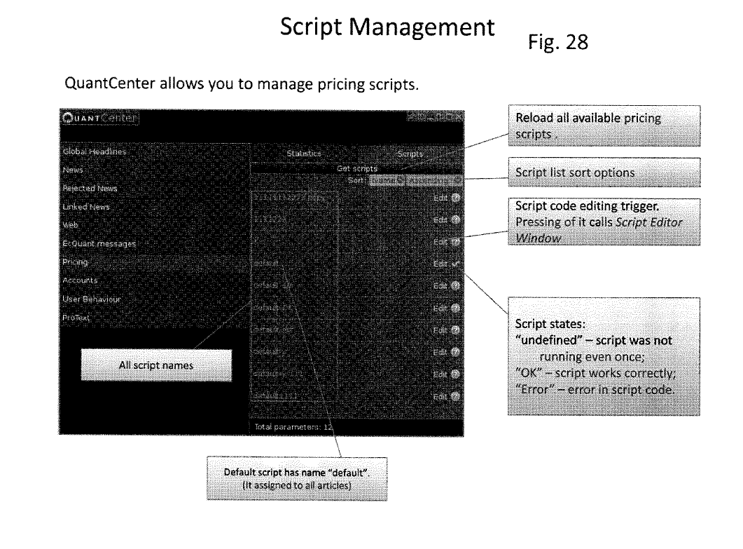

FIG. 28 illustrates an example of a display at the screen of workstation 2424 in FIG. 24 that can appear in a process of managing scripts. As indicated, the screen includes a listing of the names of the available scripts, a box to click for arranging the scripts by name or some other order, buttons to click to place a script in an editing mode, and indications whether the script has been used in the system and whether it has been found to work correctly or to contain errors.

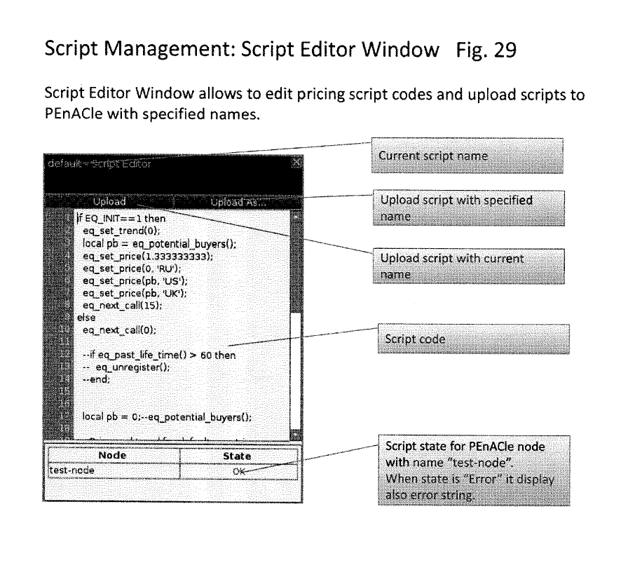

FIG. 29 illustrates an example of a display at the screen of workstation 2424 in FIG. 24 that can appear in a process of managing scripts. In this non-limiting example, the top line shows the name of the current script (in this case a default script). The next line has a box labeled “upload” that can be checked to upload the current script under its current name for use in the pricing engine, and a box “upload as . . . ” that can be clicked to upload the script under a newly assigned name. The lines underneath are script code that a user may write or modify to create or edit a script.

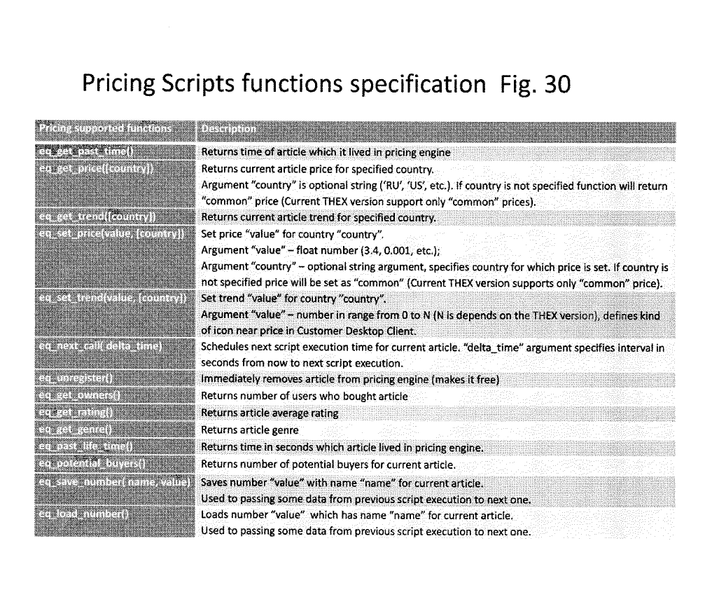

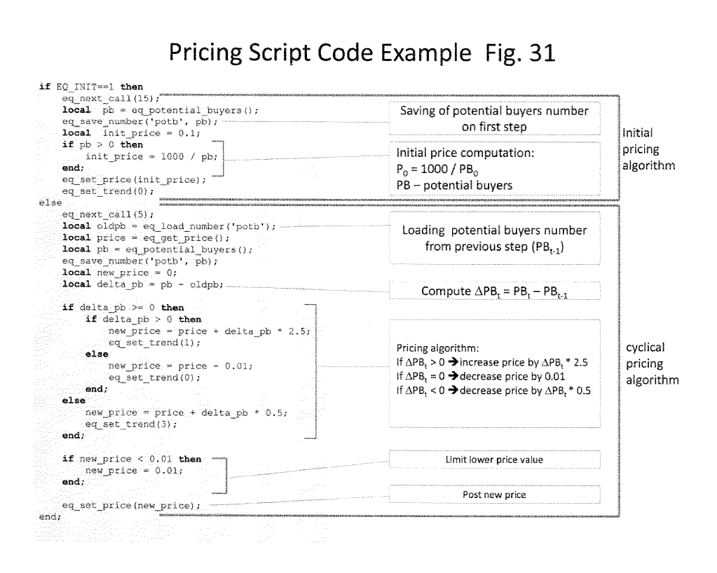

FIG. 30 illustrates further details about an example of script commands by providing comments (descriptions) of the illustrated commands or functions, and FIG. 31 illustrates a commented example of a pricing script code.

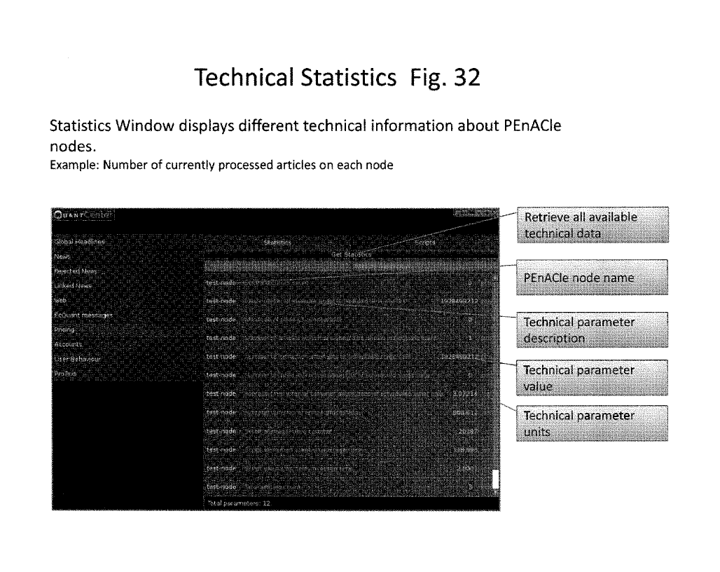

FIG. 32 illustrates a screen that may be displayed at workstation 2422 of FIG. 1 to provide statistical information about the pricing engine operation. The left column allows an administrator to select the type of statistical or other information that should be displayed; in this example “pricing” has been selected. Boxes to the right allow the selection of statistics (selected in this example) or scripts. In the illustrated example, a test node has been selected, and the several parameters about the pricing engine operation are displayed as named accordingly, and values are given for each of the named parameter to allow a system administration to assess performance or maintain supervision and consider design improvements.

The system can be further configured to add promotional material such as third party advertisement to the articles, answers or other material provided to users. In that case, the system is configured to derive revenue from the third parties related to the volume, nature and timing of the promotional material and perhaps other factors. Arrangements for such delivery of third party promotional material and derivation of revenue therefrom are well known and in commercial use by entities such as Google and others, and for the sake of conciseness need not be described in detail in this patent specification.

It should be understood that while separate servers and processors are illustrated related to different functions of the system, these functions can be distributed differently among one or more servers and processors that can be at the same location or at different locations, or can all be performed in one server or server cluster or processor, consistent with the operation of the system and carrying out the functions described above. Similarly, the articles database server functionality can be in one place or distributed among different places and devices. Therefore, references to servers in this patent specification and claims should be understood to be based on functions rather than on a physical devices or locations.

An application program that interacts with publishers and users, and with one or more servers, to carry out an example of the process described above can be incorporated in or used through an operating system such as Windows from Microsoft, or can be made accessible through browsers, or made available to publishers or users in some other way. A suitable program can be loaded on publishers' and/or users' devices to facilitate interaction with system server 16, or similar interaction can be provided solely through pre-existing facilities of the devices that publishers/users operate, or through a cloud arrangement. A specific program can be written, or a specific programmed system can be assembled, without undue experimentation, according to the description above, to implement an example of the disclosed method and system adapted for a particular setting and/or to meet particular goals. The program can be stored in a non-transitory form in computer-readable media such as magnetic or optical disc, and/or semi-conductor memory and, when loaded and executed in general purpose computer systems, can carry out the process described above.

While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features or other described embodiments. Further, like reference numbers and designations in the various drawings indicate like elements.

The foregoing has been described in some detail for purposes of clarity but it will be apparent that certain changes and modifications may be made without departing from the principles thereof. A person skilled in the pertinent technology would understand that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims

This patent specification thus describes a basic computer-implemented system configured to provide dynamic, essentially real time pricing of users' access to content represented by articles, which pricing can vary over time with user behavior to reflect actual values that users place on access to the articles and/or answers. The system comprises a computer-implemented facility through which users may access published articles, post questions, provide answers thereto, and access answers, and a pricing application cluster configured to apply scripts to content maintained in an articles/answers database server to thereby iteratively generate prices for access by remotely located users to the desired content

The patent specification further describes an improvement that further enhances the system by freezing the price for access to an article that a user has selected for some time to allow the user to complete the purchase of access to that article. The implementation of this improvement may involve freezing the price until the occurrence of an event, or only in case the price is going up, or only if the price changes in some other way, such as going up at a specified rate.

1. A computer-implemented system configured to provide a remotely located user with time to complete access to a selected article at a price that relates to the price offered at the time the user selected the article, in an environment of providing dynamic, essentially real time pricing of access to content by remotely located users, which pricing varies over time with user behavior to reflect actual values that users place on access to the articles, said system comprising:
a computer-implemented articles database configured to store and update articles stored in the system and parameters related to the articles;
a computer-implemented system server configured to electronically link the articles database with remotely located publishers and users and provide the publishers and users with selected granulated entry to the articles database from remote locations;
a price holding facility configured to respond to a user's selection of an article communicated through said system server to hold the access price for the article at a selected level for a selected time period until the user completes purchase of access to the article or the selected time expires;
a pricing application cluster configured to apply, in a computer-implemented process, respective pricing scripts to articles to thereby iteratively generate access prices for access to the respective articles by remotely located users, and to apply the help price when the user completes purchase of access to the article;
said pricing application cluster being further configured to generate different prices for access to the articles at different times to thereby generate prices that vary over time based at least in part on user behavior; and
said pricing application cluster being further configured to charge users for access to the respective articles including selectively providing different access charges, schedules, or terms for different categories of users and articles.

2. The system of claim 1 in which said system server is further configured to supply, to the articles database, articles contributed by the publishers, and said pricing applications cluster is further configured to calculate and post on the system respective access prices for access by respective users to respective articles, which prices vary in time at least with user behavior.

3. The system of claim 2 in which the pricing application server is configured to calculate the access prices based on a respective sets of scripts assigned to respective articles and answers.

4. The system of claim 3 in which said pricing application clusters is configured to calculate an initial access price for an article based at least in part on a total price for the article proposed to the system by the publisher of the article.

5. The system of claim 4 including a center server coupled with at least one of the pricing application server and the articles database and configured to store historical information regarding the articles and attributes thereof, and to calculate and provide for display to publishers or users estimates of future readership of or access to articles and answers.

6. The system of claim 1 in which the pricing application cluster is further configured to calculate different access prices for users in different geographical areas.

7. The system of claim 1 in which the pricing application cluster is further configured to calculate different access prices for users who are in different categories, including a category of pay-per-view users and a category of subscription users.

8. The system of claim 7 in which said category of subscription users comprises different categories of subscription users and said pricing application cluster is configured to calculate different access prices for the different subscription categories.

9. The system of claim 1 in which the system server and the articles database are configured to aggregate questions with follow-up questions posted on the system and with answers to the follow-up questions, and to display said aggregations to users.

10. A computer-implemented method configured to provide a remotely located user with time to complete access to a selected article at a price that relates to the price offered at the time the user selected the article, in an environment of providing dynamic, essentially real time pricing of access to content by remotely located users, which pricing varies over time with user behavior to reflect actual values that users place on access to the articles, said system comprising:
storing and updating articles and parameters related thereto in a computer-implemented articles database;
electronically linking the articles database with remotely located publishers and users and providing the publishers and users with selected granulated entry to the articles database from remote locations;
providing a price holding facility configured to respond to a user's selection of an article communicated through said system server to hold the access price for the article at a selected level for a selected time period until the user completes purchase of access to the article or the selected time expires;
providing a pricing application cluster configured to apply, in a computer-implemented process, respective pricing scripts to articles to thereby iteratively generate access prices for access to the respective articles by remotely located users, and to apply the help price when the user completes purchase of access to the article;
said pricing application cluster being further configured to generate different prices for access to the articles at different times to thereby generate prices that vary over time based at least in part on user behavior; and
said pricing application cluster being further configured to charge users for access to the respective articles including selectively providing different access charges, schedules, or terms for different categories of users and articles.

11. The method of claim 10 further including supplying, to the articles database, articles contributed by the publishers, and calculating and posting on the system respective access prices for access by respective users to respective articles, which prices vary in time at least with user behavior.

12. The method of claim 11 including calculating the access prices based on a respective sets of scripts assigned to respective articles and answers.

13. The method of claim 12 including calculating an initial access price for an article based at least in part on a total price for the article proposed to the system by the publisher of the article.

14. The method of claim 13 including storing, in computer storage, historical information regarding the articles and answers and attributes thereof, and calculating and providing for display to publishers or users estimates of future readership of or access to articles and answers.

15. The method of claim 10 including calculating different access prices for users in different geographical areas.

16. The method of claim 10 including calculating different access prices for users who are in different categories, including a category of pay-per-view users and a category of subscription users.

17. The method of claim 16 in which the category of subscription users comprises assigning different access charges to different categories of subscribing users.

18. The method of claim 10 including aggregating questions with follow-up questions posted on the system and with answers to the follow-up questions, and display said aggregations to users.
